(19) United States
(12) Patent Application Publication
(10) Pub. No.: US 2023/0281470 A1
(43) Pub. Date: Sep. 7, 2023

(54) MACHINE LEARNING CLASSIFICATION OF OBJECT STORE WORKLOADS

(71) Applicant: NetApp, Inc., San Jose, CA (US)

(72) Inventors: Andy Anheng Hwang, Thornhill (CA); Timothy K. Emami, San Jose, CA (US); Sotirios Efstathios Maneas, Toronto (CA)

(21) Appl. No.: 17/653,541

(22) Filed: Mar. 4, 2022

(51) Int. Cl. G06N 5/02

(52) U.S. Cl. CPC G06N 5/022

(57) ABSTRACT

Systems/techniques that facilitate machine learning classification of object store workloads are provided. In various embodiments, a system can access a resource utilization descriptor associated with an object store. In various aspects, the system can generate, via execution of a machine learning model (e.g., a deep learning neural network, a random forest model), a classification label based on the resource utilization descriptor. In various instances, the system can perform one or more electronic actions based on the classification label. In various cases, the classification label can indicate/identify a computing fault of the object store, can indicate/identify resources of the object store that are being underutilized and/or overutilized, and/or can indicate whether a workload corresponding to the resource utilization descriptor could be properly transplanted to a different object store. Accordingly, the one or more electronic actions can include generating warnings/recommendations regarding such computing fault, such underutilized/overutilized resources, and/or such transplantation.

### TECHNICAL FIELD

The subject disclosure relates generally to object stores, and more specifically to facilitating machine learning classification of object store workloads.

### BACKGROUND

An object store can electronically record computerized objects for a client device. The volume and/or characteristics of computerized objects that are recorded in the object store on behalf of the client device, as well as the object-storage operations which the client device requests to be performed on such computerized objects, can be considered as an object store workload associated with the client device. It can be desirable to make warnings and/or recommendations to the client device regarding its object store workload. Some techniques for generating such warnings/recommendations rely on explicitly-coded heuristics. Unfortunately, such explicitly-coded heuristics are clunky, time-consuming, and not individualized. Similar problems occur with respect to making warnings and/or recommendations for the workloads of other types of electronic data stores (e.g., file stores, block stores).

Accordingly, systems and/or techniques that can address one or more of the above-described technical problems can be desirable.

### SUMMARY

The following presents a summary to provide a basic understanding of one or more embodiments described herein. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that can facilitate machine learning classification of object store workloads are described.

According to one or more embodiments, a system is provided, where the system can help to generate machine learning classifications of data store workloads. The system can include a memory that can store computer-executable components. The system can further include a processor that can be operably coupled to the memory and that can execute the computer-executable components stored in the memory. In various embodiments, the computer-executable components can include an access component that can access a resource utilization descriptor representing how a workload of a data store consumes resources of the data store. In various cases, the resource utilization descriptor can indicate at least one of a computer processing unit utilization level of the data store that is caused by the workload, a temporary computer memory utilization level of the data store that is caused by the workload, a permanent computer memory utilization level of the data store that is caused by the workload, and/or a network bandwidth utilization level of the data store that is caused by the workload. In various aspects, the computer-executable components can further include a model component that can generate, via execution of a machine learning model, a classification label based on the resource utilization descriptor. In various cases, the model component can feed the resource utilization descriptor as input to the machine learning model, the machine learning model can produce as output the classification label, and the classification label can characterize the workload of the data store. In various instances, the computer-executable components can further include an execution component that can perform one or more electronic actions based on the classification label.

According to one or more embodiments, a computer-implemented method is provided, where the computer-implemented method can help to produce warnings and/or recommendations regarding data store workloads based on machine learning classifications of such data store workloads. In various aspects, the computer-implemented method can include accessing, by a device operatively coupled to a processor, a resource utilization descriptor that represents resource-consumption of a workload of a data store. In various cases, the resource utilization descriptor can include one or more computer processing unit utilization levels of the data store that are caused by the workload and/or can include one or more permanent computer memory utilization levels of the data store that are caused by the workload. In various instances, the computer-implemented method can further include generating, by the device and via execution of a machine learning model on the resource utilization descriptor, a classification label that describes a characteristic of the workload of the data store. In various cases, the machine learning model can receive as input the resource utilization descriptor and can compute as output the classification label. In various aspects, the computer-implemented method can further include generating, by the device, one or more warnings or recommendations based on the classification label.

According to one or more embodiments, a computer program product is provided, where the computer program product can help to facilitate machine learning classification of workloads of a data store so as to support provision of tailored warnings and/or recommendations regarding the data store. In various aspects, the computer program product can include a computer-readable memory having program instructions embodied therewith. In various instances, the program instructions can be executable by a processor to cause the processor to access a resource utilization descriptor conveying how a workload handled by a data store causes various resources of the data store to be consumed. In various cases, the resource utilization descriptor can indicate a computer processing unit utilization level of the data store that is caused by the workload, a temporary computer memory utilization level of the data store that is caused by the workload, a permanent computer memory utilization level of the data store that is caused by the workload, and/or a network bandwidth utilization level of the data store that is caused by the workload. In various aspects, the program instructions can be further executable to cause the processor to execute a machine learning model on the resource utilization descriptor, thereby yielding a classification label that qualifies the workload. In various cases, the machine learning model can take as input the resource utilization descriptor and can calculate as output the classification label. In various instances, the program instructions can be further executable to cause the processor to transmit, to a client device associated with the workload, at least one warning or recommendation based on the classification label.

### DESCRIPTION OF THE DRAWINGS

FIG. 1 illustrates a block diagram of an example, non-limiting system that facilitates machine learning classification of object store workloads in accordance with one or more embodiments described herein.

FIG. 2 illustrates an example, non-limiting block diagram showing a resource utilization descriptor in accordance with one or more embodiments described herein.

FIGS. 3-4 illustrate example, non-limiting graphs showing variation in utilization of different resources in accordance with one or more embodiments described herein.

FIG. 5 illustrates a block diagram of an example, non-limiting system including a machine learning model and a classification label that facilitates machine learning classification of object store workloads in accordance with one or more embodiments described herein.

FIG. 6 illustrates an example, non-limiting block diagram showing how a machine learning model can generate a classification label based on a resource utilization descriptor in accordance with one or more embodiments described herein.

FIG. 7 illustrates a block diagram of an example, non-limiting system including a set of warnings/recommendations that facilitates machine learning classification of object store workloads in accordance with one or more embodiments described herein.

FIG. 8 illustrates a block diagram of an example, non-limiting system including a training component and a training dataset that facilitates machine learning classification of object store workloads in accordance with one or more embodiments described herein.

FIG. 9 illustrates an example, non-limiting block diagram showing a training dataset in accordance with one or more embodiments described herein.

FIG. 10 illustrates an example, non-limiting block diagram showing how a machine learning model can be trained based on a training dataset in accordance with one or more embodiments described herein.

FIG. 11 illustrates a flow diagram of an example, non-limiting computer-implemented method that facilitates machine learning classification of object store workloads in accordance with one or more embodiments described herein.

FIG. 12 illustrates a flow diagram of an example, non-limiting computer-implemented method that facilitates machine learning classification of object store workloads in accordance with one or more embodiments described herein.

FIG. 13 illustrates a block diagram of an example, non-limiting operating environment in which one or more embodiments described herein can be facilitated.

FIG. 14 illustrates an example, non-limiting cloud computing environment in accordance with one or more embodiments described herein.

FIG. 15 illustrates example, non-limiting abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

An object store (e.g., an object-oriented database, such as a cloud storage platform) can electronically record computerized objects for a client device (e.g., a client laptop computer, a client desktop computer, a client smart phone). The volume and/or characteristics of computerized objects that are recorded in the object store on behalf of the client device, as well as the object-storage operations (e.g., GET operations, HEAD operations, DELETE operations) which the client device requests to be performed on such computerized objects, can be considered as an object store workload associated with the client device.

Generally, it can be desirable to electronically transmit warnings and/or recommendations to the client device regarding its object store workload. For example, if the object store workload of the client device is overutilizing a given resource of the object store (e.g., is overutilizing a computer processing unit of the object store, is overutilizing a hard disk drive and/or solid state drive of the object store, is overutilizing a random access memory of the object store, is overutilizing a network communication channel of the object store), it would be beneficial to warn the client device of such overutilization and/or to otherwise recommend to the client device that utilization of such resource be decreased. Otherwise, such overutilization would continue, which could be wasteful and thus undesirable for the client device. As another example, if the object store workload of the client device is experiencing a given electronic error (e.g., a compilation error, a runtime error, a resource error), it would be beneficial to warn the client device of such given electronic error and/or to otherwise recommend to the client device how such given electronic error can be mitigated. Otherwise, the given electronic error would continue unabated, which could jeopardize data of the client device. Accordingly, the provision of accurate and tailored warnings/recommendations to a client device regarding an object store workload of the client device can be considered as an important technical problem to be solved and/or as a valuable technical service to be provided.

Some potential techniques for generating such warnings/recommendations rely on explicitly-coded heuristics. That is, such techniques sequentially apply tens, hundreds, or even thousands of manually-coded rules (e.g., Boolean expressions) to an object store workload associated with a client device, and the logical outputs of such manually-coded rules determine which warnings/recommendations ought to be transmitted to the client device. Unfortunately, such explicitly-coded heuristics are clunky and time-consuming to prepare (e.g., such heuristics must be manually-coded by software engineers, which can consume excessive amounts of time and/or man-hours). Furthermore, such explicitly-coded heuristics are far more subjective than objective (e.g., such heuristics can be considered as “rules-of-thumb” that are based on “gut intuitions” and/or “guesstimates” of software engineers, as opposed to being based on objective data-driven metrics). Further still, such explicitly-coded heuristics are uniform and/or not individualized to particular clients (e.g., all object store workloads are subjected to the same explicitly-coded heuristics, and thus the same/common set of warnings/recommendations, regardless of significant differences between such object store workloads).

Systems and/or techniques that can address one or more of these technical problems can thus be desirable.

Various embodiments described herein can address one or more of these technical problems. Specifically, various embodiments described herein can provide systems and/or techniques that can facilitate machine learning classification of object store workloads.

As mentioned above, some techniques for generating warnings and/or recommendations for object store workloads merely rely upon explicitly-coded heuristics, which are time-consuming, subjective, and non-individualized. Moreover, such disadvantages of heuristic techniques are exacerbated by the massive size of modern object stores. In other words, although heuristic techniques may have worked somewhat appropriately in the past for low-volume object store workloads, modern object stores (e.g., modern cloud platforms, such as S3) have exponentially larger workloads (e.g., can store hundreds of billions of objects, can utilize tens of thousands of terabytes of memory space, can receive thousands of object-storage operation requests per second), and such exponentially larger workloads can render heuristic techniques even more clunky and inconvenient.

Fortunately, the inventors of various embodiments described herein devised a technique by which such warnings and/or recommendations for object store workloads can be generated in a less time-consuming, less subjective, and/or more individualized fashion. Specifically, the present inventors recognized that different clients can have significantly different object store workloads. For example, object store workloads can vary in terms of resource utilization (e.g., in terms of computer processing unit (CPU) utilization, in terms of disk utilization, in terms of memory utilization, and/or in terms of network bandwidth utilization). Accordingly, the present inventors realized that an object store workload can be classified, via a trained machine learning classifier, based on its resource utilization, and the present inventors further realized that such classification can then be leveraged to decide which warnings and/or recommendations should be generated for the object store workload. Such object store workload classification can be considered as less time-consuming than explicitly-coded heuristic techniques (e.g., once trained, a machine learning classifier can generate inferences in a very quick, non-time-consuming fashion). Moreover, such object store workload classification can be considered as more objective than explicitly-coded heuristic techniques (e.g., explicitly-coded heuristics are subjective “rules-of-thumb” that are manually crafted by software engineers, whereas a machine learning classifier can be trained to minimize an objective error and/or loss metric in a data-driven fashion). Furthermore, such object store workload classification can enable more individualized and/or individually-tailored warnings/recommendations to be generated for different object store workloads (e.g., different types of warnings/recommendations can be available for different classifications of object store workloads, whereas only a common set of warnings/recommendations are available for all object store workloads when heuristics are employed). Further still, such object store workload classification can be considered as more scalable than explicitly-coded heuristic techniques (e.g., machine learning classification can be implemented regardless of the size and/or volume of object store workload).

Various embodiments described herein can be considered as a computerized tool for facilitating machine learning classification of object store workloads. In various aspects, such a computerized tool can comprise an access component, a model component, and/or an execution component.

In various embodiments, there can be an object store. In various aspects, the object store can be any suitable object-oriented database as desired (e.g., an object-oriented cloud database, such as S3). In various instances, there can be a resource utilization descriptor associated with the object store. In various cases, the resource utilization descriptor can be any suitable piece and/or collection of electronic data that conveys and/or otherwise indicates how various electronic and/or computerized resources (e.g., processors, hard disk drives (HDDs), solid state drives (SSDs), random access memories (RAMs), and/or network communication channels) of the object store are being used, operated, and/or consumed. For example, in various aspects, the resource utilization descriptor can include one or more scalars, vectors, matrices, tensors, character strings, and/or any suitable combination thereof that indicate and/or convey one or more CPU utilizations of the object store (e.g., a CPU utilization can be a ratio between an amount of work and/or computing that is actually being performed by a processor to a maximum amount of work and/or computing that could be performed by the processor). As another example, the resource utilization descriptor can include one or more scalars, vectors, matrices, tensors, character strings, and/or any suitable combination thereof that indicate and/or convey one or more disk utilizations of the object store (e.g., a disk utilization can be a ratio between an amount of memory space that is actually consumed in an HDD and/or SSD to a maximum amount of memory space that could be consumed in that HDD and/or SSD). As still another example, the resource utilization descriptor can include one or more scalars, vectors, matrices, tensors, character strings, and/or any suitable combination thereof that indicate and/or convey one or more memory utilizations of the object store (e.g., a memory utilization can be a ratio between an amount of memory space that is actually consumed by a RAM to a maximum amount of memory space that could be consumed by that RAM). As yet another example, the resource utilization descriptor can include one or more scalars, vectors, matrices, tensors, character strings, and/or any suitable combination thereof that indicate and/or convey one or more network bandwidth utilizations of the object store (e.g., a network bandwidth utilization can be a ratio between an amount of traffic and/or bandwidth that is actually consumed in a network communication channel to a maximum amount of traffic and/or bandwidth that could be consumed in that network communication channel).

In any case, the resource utilization descriptor can be considered as representing how various resources of the object store are being utilized by a particular workload of the object store. Accordingly, it can be desired to classify the particular workload of the object store, so that appropriate warnings and/or recommendations for the particular workload can be generated. As described herein, the computerized tool can facilitate such classification.

In various embodiments, the access component of the computerized tool can electronically receive and/or access the resource utilization descriptor. In some aspects, the access component can electronically retrieve the resource utilization descriptor from any suitable database and/or data structure as desired (e.g., graph data structure, relational data structure, hybrid data structure), whether remote from and/or local to the access component. For example, in some cases, the access component can retrieve and/or obtain the resource utilization descriptor from the object store itself. In other aspects, however, the access component can electronically retrieve and/or obtain the resource utilization descriptor from any other suitable computing device as desired. In any case, the access component can electronically access the resource utilization descriptor, so that other components of the computerized tool can electronically interact with (e.g., read, write, edit, manipulate) the resource utilization descriptor.

In various embodiments, the model component of the computerized tool can electronically store, electronically maintain, electronically control, and/or otherwise electronically access a machine learning model. In various aspects, the machine learning model can exhibit any suitable artificial intelligence architecture as desired. For example, the machine learning model can exhibit a deep learning neural network architecture. In such case, the machine learning model can include any suitable number of layers (e.g., input layer, one or more hidden layers, output layer), can include any suitable numbers of neurons in various layers (e.g., different layers can have the same and/or different numbers of neurons as each other), can include any suitable activation functions (e.g., softmax, sigmoid, hyperbolic tangent, rectified linear unit) in various neurons (e.g., different neurons can have the same and/or different activation functions as each other), and/or can include any suitable interneuron connections (e.g., forward connections, skip connections, recurrent connections). As another example, the machine learning model can exhibit a random forest architecture. In such case, the machine learning model can include any suitable number of decision trees (e.g., a random forest model can be considered as an ensemble of decision trees), any suitable numbers of decision nodes in various decision trees (e.g., different decision trees can have the same and/or different numbers of decision nodes as each other), any suitable decision thresholds in various decision nodes (e.g., different decision nodes can have the same and/or different decision threshold values as each other), any suitable numbers of leaf nodes in various decision trees (e.g., different decision trees can have the same and/or different numbers of leaf nodes as each other), and/or any suitable classification thresholds in various leaf nodes (e.g., different leaf nodes can have the same and/or different classification threshold values as each other). In various other aspects, the machine learning model can exhibit any other suitable architecture as desired (e.g., support vector machine, linear and/or logistic regression, naïve Bayes, k-means clustering).

In any case, the machine learning model can be configured to receive as input the resource utilization descriptor, and to produce as output a classification label based on the resource utilization descriptor. In various aspects, the classification label can be any suitable scalar, vector, matrix, tensor, character string, and/or any suitable combination thereof that indicates and/or otherwise conveys a class to which the resource utilization descriptor belongs (e.g., to which the machine learning model believes and/or infers that the object store workload represented by the resource utilization descriptor belongs).

For example, in some cases, the classification label can indicate and/or convey what type and/or category of object store workload is represented by the resource utilization descriptor. Non-limiting examples of different types and/or categories of object store workloads can include an electronic design automation type/category (e.g., such an object store workload can be associated with an institution that designs, manufactures, and/or tests/analyzes products), a financial services type/category (e.g., such an object store workload can be associated with a banking institution and/or an electronic payment processing institution), and/or a retail services type/category (e.g., such an object store workload can be associated with an online vending institution that sells and/or delivers products via internet transactions). In any case, different types/categories of object store workloads can correspond to and/or be correlated with different resource utilization descriptors. Accordingly, the machine learning model can be configured to identify and/or infer a type/category of object store workload, based on (e.g., by analyzing) the resource utilization descriptor of the object store.

As another example, in various aspects, the classification label can indicate and/or convey an electronic anomaly, computing fault, and/or system error that is afflicting the object store workload represented by the resource utilization descriptor. Non-limiting examples of electronic anomalies, computing faults, and/or system errors can include any suitable types of runtime errors, any suitable types of compilation errors, any suitable types of logic errors, any suitable types of syntax errors, any suitable types of interface errors, any suitable types of resource errors, and/or any suitable types of arithmetic errors. In any case, different anomalies/faults/errors of the object store can correspond to and/or be correlated with different resource utilization descriptors. Accordingly, the machine learning model can be configured to identify and/or infer an anomaly/fault/error afflicting the object store, based on (e.g., by analyzing) the resource utilization descriptor of the object store.

As still another example, in various instances, the classification label can indicate and/or convey one or more resources of the object store that are being overutilized and/or underutilized by the object store workload represented by the resource utilization descriptor. For instance, the classification label can identify which CPUs of the object store are being worked too hard and/or too little, which HDDs and/or SSDs of the object store are being worked too hard and/or too little, which RAMs of the object store are being worked too hard and/or too little, and/or which network communication channels of the object store are being worked too hard and/or too little. In any case, different overused and/or underused resources of the object store can correspond to and/or be correlated with different resource utilization descriptors. Accordingly, the machine learning model can be configured to identify and/or infer which resources of the object store are being overused and/or underused, based on (e.g., by analyzing) the resource utilization descriptor of the object store.

As yet another example, in various cases, the classification label can indicate and/or convey whether the object store workload represented by the resource utilization descriptor can be successfully and/or appropriately transplanted and/or transferred to a different (e.g., differently configured, differently structured, differently designed) object store. In other words, different object stores can be configured and/or designed to handle different object store workloads (e.g., different object stores can have different processing capacities, different disk capacities, different memory capacities, and/or different channel bandwidth capacities). Accordingly, the machine learning model can be configured to identify and/or infer, based on (e.g., by analyzing) the resource utilization descriptor, whether the object store workload represented by the resource utilization descriptor can be successfully and/or appropriately transplanted to a new object store that is differently configured than the current object store.

As even another example, in various aspects, the classification label can indicate and/or convey a proposed and/or recommended configuration change for the object store. As mentioned above, different object stores can be configured and/or designed to handle different object store workloads (e.g., different object stores can have different processing capacities, different disk capacities, different memory capacities, and/or different channel bandwidth capacities). Accordingly, the machine learning model can be configured to infer and/or propose a configuration change (e.g., to add and/or subtract CPU capacity, to add and/or subtract disk capacity, to add and/or subtract memory capacity, to add and/or subtract network bandwidth capacity) for the object store, based on (e.g., by analyzing) the resource utilization descriptor of the object store.

In any case, the model component can electronically generate the classification label by executing the machine learning model on the resource utilization descriptor. For example, if the machine learning model is a neural network, then the resource utilization descriptor can be fed to an input layer of the machine learning model, the resource utilization descriptor can complete a forward pass through one or more hidden layers of the machine learning model, and an output layer of the machine learning model can compute the classification label based on activations provided by the one or more hidden layers. As another example, if the machine learning model is instead a random forest model, then the resource utilization descriptor can be fed to a root node of each decision tree of the random forest model, the resource utilization descriptor can pass through the branches of each decision tree, the resource utilization descriptor can be classified by a leaf node of each decision tree, and the classifications from all the decision trees can be aggregated (e.g., averaged) together to form the classification label.

In various embodiments, the execution component of the computerized tool can electronically initiate any suitable electronic actions based on the classification label. For example, if the classification label indicates a type and/or category of the object store workload that is represented by the resource utilization descriptor, then the execution component can electronically generate any suitable warning and/or recommendation based on that type and/or category (e.g., if other object store workloads of the same type/category have been afflicted by a particular fault/error, the execution component can warn that the object store workload that is represented by the resource utilization descriptor might become afflicted by that particular fault/error; if other object store workloads of the same type/category have been updated in a particular fashion, the execution component can recommend that the object store workload that is represented by the resource utilization descriptor should also be updated in such particular fashion).

As another example, if the classification label indicates an anomaly, error, and/or fault of the object store, then the execution component can electronically generate any suitable warning and/or recommendation based on that anomaly, error, and/or fault (e.g., the execution component can transmit a warning to a client device that is associated with the resource utilization descriptor, which warning indicates and/or notifies that the anomaly/fault/error has been detected; the execution component can transmit a recommendation to a client device that is associated with the resource utilization descriptor, which recommendation suggests how to remedy the anomaly/fault/error).

As yet another example, if the classification label indicates an overutilized and/or underutilized resource of the object store, then the execution component can electronically generate any suitable warning and/or recommendation based on such overutilized and/or underutilized resource (e.g., the execution component can transmit a warning to a client device that is associated with the resource utilization descriptor, which warning indicates and/or notifies that the overutilized/underutilized resource has been detected; the execution component can transmit a recommendation to a client device that is associated with the resource utilization descriptor, which recommendation suggests how to decrease/increase utilization of such resource).

As still another example, if the classification label indicates whether the object store workload represented by the resource utilization descriptor can be appropriately/successfully transplanted to a different object store, then the execution component can electronically generate any suitable warning and/or recommendation based on that inference (e.g., the execution component can transmit a warning to a client device that is associated with the resource utilization descriptor indicating and/or notifying that the object store workload that is represented by the resource utilization descriptor can and/or cannot be successfully/appropriately transplanted to a differently-configured object store).

In various embodiments, the above-described functionality of the machine learning model can be considered as inferencing of the machine learning model. In order to facilitate accurate inferencing of the machine learning model, the machine learning model should first undergo training. Accordingly, the computerized tool can, in various aspects, further comprise a training component, and the training component can electronically train the machine learning model on a training dataset that includes a set of training resource utilization descriptors. In some cases, the training dataset can be annotated (e.g., each training resource utilization descriptor can have a corresponding ground-truth annotation), and the training component can thus perform supervised training of the machine learning model.

For example, suppose that the machine learning model is a random forest model comprising multiple decision trees. In such case, the training component can fit each of such multiple decision trees to the training dataset via any suitable sample splitting techniques (e.g., splitting the training dataset according to annotation based on estimate of positive correctness, splitting the training dataset according to annotation based on Gini impurity, splitting the training dataset according to annotation based on information gain, splitting the training dataset according to annotation based on variance reduction, splitting the training dataset according to annotation based on measure of “goodness”). Furthermore, in various instances, the training component can perform any suitable pruning techniques (e.g., reduced error pruning, cost complexity pruning) on each of such multiple decision trees after such sample splitting. In any case, the ultimate result can be that each of the multiple decision trees of the machine learning model now has internal parameters (e.g., decision node locations, decision node thresholds, leaf node locations, and/or leaf node thresholds) that have been optimized to accurately classify inputted resource utilization descriptors.

As another example, suppose that the machine learning model is instead a deep learning neural network. In such case, the internal parameters (e.g., weights, biases) of the machine learning model can be randomly initialized. In various aspects, the training component can select, from the training dataset, a training resource utilization descriptor and an annotation that corresponds to the training resource utilization descriptor. In various instances, the training component can feed the selected training resource utilization descriptor as input to the machine learning model, which can cause the machine learning model to produce some output. More specifically, in various cases, an input layer of the machine learning model can receive the selected training resource utilization descriptor, the selected training resource utilization descriptor can complete a forward pass through one or more hidden layers of the machine learning model, and an output layer of the machine learning model can compute the output based on activations provided by the one or more hidden layers of the machine learning model. In various instances, the output can be considered as the inferred classification which the machine learning model believes should correspond to the selected training resource utilization descriptor, whereas the selected annotation can be considered as the ground-truth classification that is known to correspond to the selected training resource utilization descriptor. Note that, if the machine learning model has so far undergone no and/or little training, then the output can be highly inaccurate (e.g., the output can be very different from the selected annotation). In any case, the training component can compute an error and/or loss between the output and the selected annotation, and the training component can update the internal parameters of the machine learning model by performing backpropagation based on the computed error and/or loss. In various instances, the training component can repeat this training procedure for each (and/or fewer, in some cases) training resource utilization descriptor in the training dataset, with the ultimate result being that the internal parameters (e.g., weights, biases) of the machine learning model can become iteratively optimized to accurately classify inputted resource utilization descriptors. Those having ordinary skill in the art will appreciate that any suitable training batch sizes, any suitable training termination criteria, and/or any suitable error/loss functions can be implemented by the training component as desired.

Although the herein disclosure mainly discusses embodiments where the training dataset is annotated and thus where the training component performs supervised training on the machine learning model, this is a mere non-limiting example for ease of explanation. In various embodiments, the training dataset can be unannotated, and the training component can accordingly perform unsupervised training and/or reinforcement learning on the machine learning model.

In any case, the training component can electronically train the machine learning model on the training dataset, with the result being that the internal parameters (e.g., weights and/or biases for a neural network; node locations and/or node thresholds for a decision tree model; regression coefficients for a regression model) of the machine learning model can become updated and/or optimized for accurately classifying inputted resource utilization descriptors.

Accordingly, various embodiments described herein can include a computerized tool that can electronically classify, via machine learning, a workload of an object store, and that can generate any suitable warnings and/or recommendations for the object store based on such classification. More specifically, such computerized tool can receive and/or access a resource utilization descriptor that represents the workload of the object store (e.g., the resource utilization descriptor can convey CPU utilizations of the object store, permanent memory disk utilizations of the object store, temporary memory utilizations of the object store, and/or network bandwidth utilizations of the object store), such computerized tool can execute a machine learning model on such resource utilization descriptor, thereby yielding a classification label that characterizes the workload of the object store (e.g., that indicates an error afflicting the object store workload, that indicates a resource that is being overutilized and/or underutilized by the object store workload, that indicates whether the object store workload is portable to a differently-structured object store), and such computerized tool can generate, transmit, and/or render any suitable warnings/recommendations based on such classification label (e.g., can warn about a detected error of the object store, can recommend how to remedy a detected error of the object store, can warn about an overutilized/underutilized resource of the object store, can recommend how to remedy an overutilized/underutilized resource of the object store, can recommend whether or not the object store workload should be transplanted to a differently-structured object store). No existing systems and/or techniques generate classification labels by executing machine learning models on resource utilization descriptors associated with object stores. Furthermore, no existing systems and/or techniques generate warnings/recommendations for such object stores based on such classification labels.

Various embodiments described herein can be employed to use hardware and/or software to solve problems that are highly technical in nature (e.g., to facilitate machine learning classification of object store workloads), that are not abstract and that cannot be performed as a set of mental acts by a human. Further, some of the processes performed can be performed by a specialized computer (e.g., machine learning model, such as neural network or random forest). In various aspects, some defined tasks associated with various embodiments described herein can include: accessing, by a device operatively coupled to a processor, a resource utilization descriptor that represents a workload of an object store; generating, by the device and via execution of a machine learning model on the resource utilization descriptor, a classification label that characterizes the workload of the object store; and generating, by the device, one or more warnings or recommendations based on the classification label.

Neither the human mind nor a human with pen and paper can electronically access a resource utilization descriptor, electronically execute a machine learning model on the resource utilization descriptor, thereby yielding a classification label, and electronically generate warnings and/or recommendations based on the classification label. Indeed, object stores (e.g., a cloud storage platform, such as S3) and machine learning models (e.g., deep learning neural networks, random forest models) are specific combinations of computer-executable hardware and computer-executable software that cannot be implemented in any way without computers. Accordingly, a computerized tool that can electronically train and/or execute a machine learning model so as to classify an object store workload is likewise a specific combination of computer-executable hardware and/or computer-executable software that cannot be implemented in any sensible, practical, and/or reasonable way outside of a computing environment.

In various instances, one or more embodiments described herein can be integrated into a practical application. Indeed, as mentioned above, some techniques for generating warnings and/or recommendations for object store workloads rely upon explicitly-coded heuristics, which are clunky, subjective, and non-individualized. In stark contrast, various embodiments described herein, which can take the form of systems and/or computer-implemented methods, can be considered as a computerized tool that can electronically classify, via machine learning, object store workloads and that can electronically generate tailored, individualized, and/or targeted warnings and/or recommendations based on such classifications. Unlike heuristic techniques, machine learning classification can be less time-consuming (e.g., once trained, machine learning classifiers can operate quickly during inference time), can be less subjective (e.g., heuristics can be based on subjective “rules-of-thumb” crafted by software engineers, whereas machine learning classifiers are trained via objective loss and/or fit metrics), and/or can be more individualized (e.g., heuristic techniques apply a common set of warnings/recommendations to all encountered object store workloads; in contrast, when machine learning classification is implemented, different sets of warnings/recommendations can be implemented for different classes of object store workloads). A computerized tool that can classify a workload of an object store via machine learning and that can generate one or more warnings/recommendations based on such classifications addresses the shortcomings of heuristic techniques. Thus, such a computerized tool constitutes a tangible and concrete technical improvement in the field of object stores, and certainly qualifies as a useful and practical application of computers.

Furthermore, various embodiments described herein can control real-world, tangible devices based on the disclosed teachings. For example, in various aspects, various embodiments described herein can generate a classification label for a real-world workload experienced by a real-world object store (e.g., a real-world cloud database, like S3) and can electronically transmit and/or render real-world warnings/recommendations based on such classification label.

It should be appreciated that the figures and the herein disclosure describe non-limiting examples of various embodiments described herein, and it should further be appreciated that the figures are not necessarily drawn to scale.

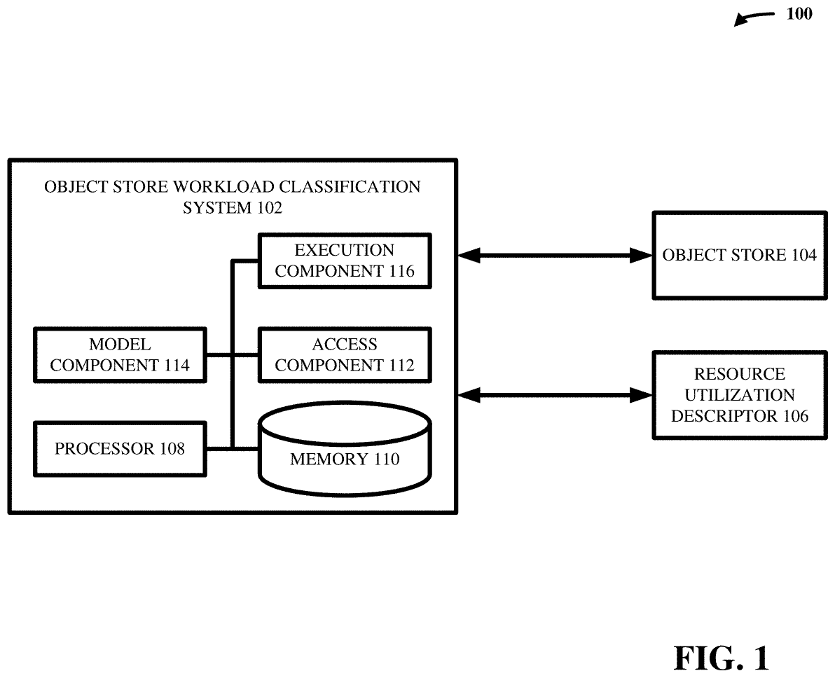

FIG. 1 illustrates a block diagram of an example, non-limiting system 100 that can facilitate machine learning classification of object store workloads in accordance with one or more embodiments described herein. As shown, an object store workload classification system 102 can be electronically integrated, via any suitable wired and/or wireless electronic connections, with an object store 104 and/or with a resource utilization descriptor 106.

In various embodiments, the object store 104 can be any suitable electronic and/or computerized database that exhibits an object-oriented architecture. As a non-limiting example, the object store 104 can be a cloud storage platform, such as S3. In any case, the object store 104 can be considered as having any suitable number of partitions, where each partition can be considered as including and/or being made up of respectively corresponding computing resources (e.g., each partition can include a respectively corresponding CPU, a respectively corresponding HDD and/or SSD, a respectively corresponding RAM, and/or a respectively corresponding network communication channel).

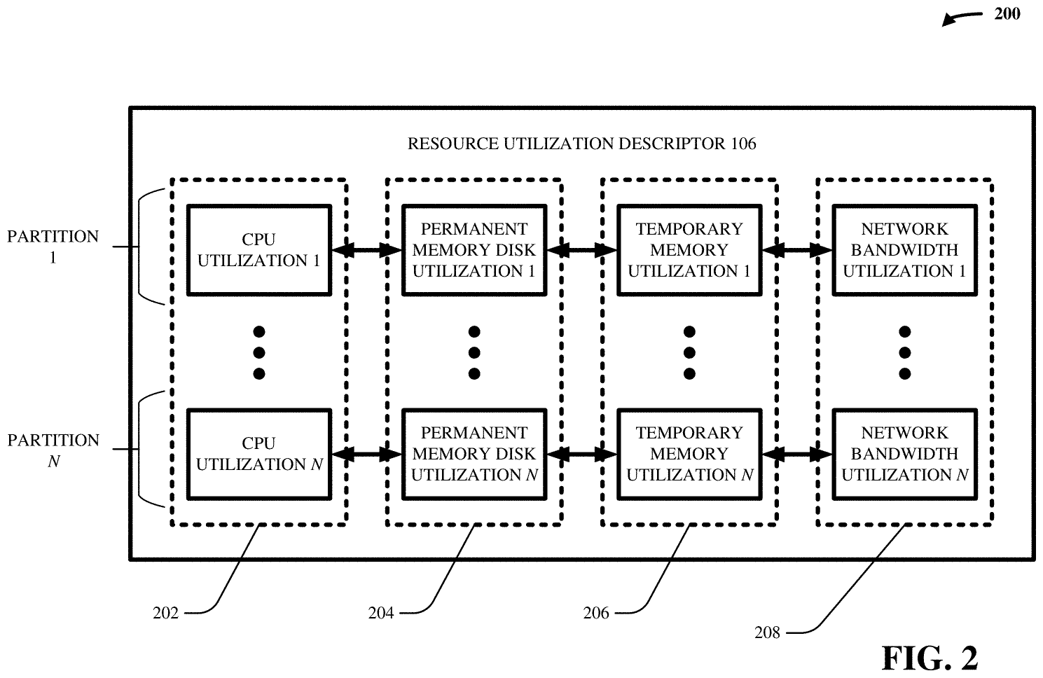

In various embodiments, the resource utilization descriptor 106 can be any suitable electronic data (e.g., having any suitable data format and/or any suitable data dimensionality) that indicates and/or otherwise conveys how the resources of the object store 104 (e.g., how the resources of each partition of the object store 104) are being utilized by a current workload of the object store 104. In other words, the resource utilization descriptor 106 can be considered as representing a workload of the object store 104. This is explained in more detail with respect to FIG. 2.

FIG. 2 illustrates an example, non-limiting block diagram 200 showing a resource utilization descriptor in accordance with one or more embodiments described herein. That is, FIG. 2 depicts an example, non-limiting embodiment of the resource utilization descriptor 106.

In various embodiments, the object store 104 can have n partitions for any suitable positive integer n: a partition 1 to a partition n. Furthermore, each of such n partitions can include its own respectively corresponding computing resources. For example, each partition can include a respectively corresponding CPU, a respectively corresponding permanent memory disk (e.g., HDD and/or SSD), a respectively corresponding temporary memory (e.g., RAM), and/or a respectively corresponding network communication channel. Accordingly, in various aspects, the resource utilization descriptor 106 can include a set of CPU utilizations 202 that respectively correspond to the n partitions, a set of permanent memory disk utilizations 204 that respectively correspond to the n partitions, a set of temporary memory utilizations 206 that respectively correspond to the n partitions, and/or a set of network bandwidth utilizations 208 that respectively correspond to the n partitions.

Since the set of CPU utilizations 202 can respectively correspond to the n partitions of the object store 104, the set of CPU utilizations 202 can include n utilizations: a CPU utilization 1 to a CPU utilization n. In various aspects, the CPU utilization 1 can be a scalar ratio whose denominator indicates a maximum processing capacity of the CPU that belongs to the partition 1 and whose numerator indicates a currently-consumed (or consumed on average) processing capacity of the CPU that belongs to the partition 1. Likewise, in various instances, the CPU utilization n can be a scalar ratio whose denominator indicates a maximum processing capacity of the CPU that belongs to the partition n and whose numerator indicates a currently-consumed (or consumed on average) processing capacity of the CPU that belongs to the partition n.

In various aspects, since the set of permanent memory disk utilizations 204 can respectively correspond to the n partitions of the object store 104, the set of permanent memory disk utilizations 204 can include n utilizations: a permanent memory disk utilization 1 to a permanent memory disk utilization n. In various aspects, the permanent memory disk utilization 1 can be a scalar ratio whose denominator indicates a maximum storage capacity of the permanent memory disk (e.g., of the HDD and/or of the SSD) that belongs to the partition 1 and whose numerator indicates a currently-consumed (or consumed on average) storage capacity of the permanent memory disk that belongs to the partition 1. Similarly, in various instances, the permanent memory disk utilization n can be a scalar ratio whose denominator indicates a maximum storage capacity of the permanent memory disk (e.g., HDD and/or SSD) that belongs to the partition n and whose numerator indicates a currently-consumed (or consumed on average) storage capacity of the permanent memory disk that belongs to the partition n.

In various instances, since the set of temporary memory utilizations 206 can respectively correspond to the n partitions of the object store 104, the set of temporary memory utilizations 206 can include n utilizations: a temporary memory utilization 1 to a temporary memory utilization n. In various aspects, the temporary memory utilization 1 can be a scalar ratio whose denominator indicates a maximum storage capacity of the temporary memory (e.g., of the RAM) that belongs to the partition 1 and whose numerator indicates a currently-consumed (or consumed on average) storage capacity of the temporary memory that belongs to the partition 1. Likewise, in various instances, the temporary memory utilization n can be a scalar ratio whose denominator indicates a maximum storage capacity of the temporary memory (e.g., RAM) that belongs to the partition n and whose numerator indicates a currently-consumed (or consumed on average) storage capacity of the temporary memory that belongs to the partition n.

In various cases, since the set of network bandwidth utilizations 208 can respectively correspond to the n partitions of the object store 104, the set of network bandwidth utilizations 208 can include n utilizations: a network bandwidth utilization 1 to a network bandwidth utilization n. In various aspects, the network bandwidth utilization 1 can be a scalar ratio whose denominator indicates a maximum traffic bandwidth capacity of the network communication channel hat belongs to the partition 1 and whose numerator indicates a currently-consumed (or consumed on average) traffic bandwidth capacity of the network communication channel that belongs to the partition 1. Similarly, in various instances, the network bandwidth utilization n can be a scalar ratio whose denominator indicates a maximum traffic bandwidth capacity of the network communication channel that belongs to the partition n and whose numerator indicates a currently-consumed (or consumed on average) traffic bandwidth capacity of the network communication channel that belongs to the partition n.

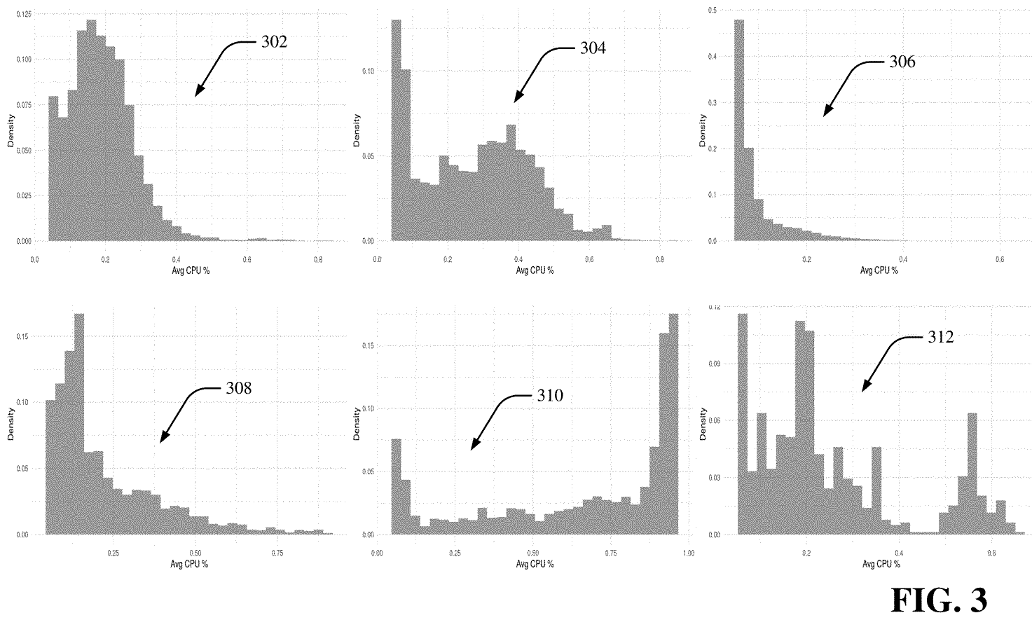

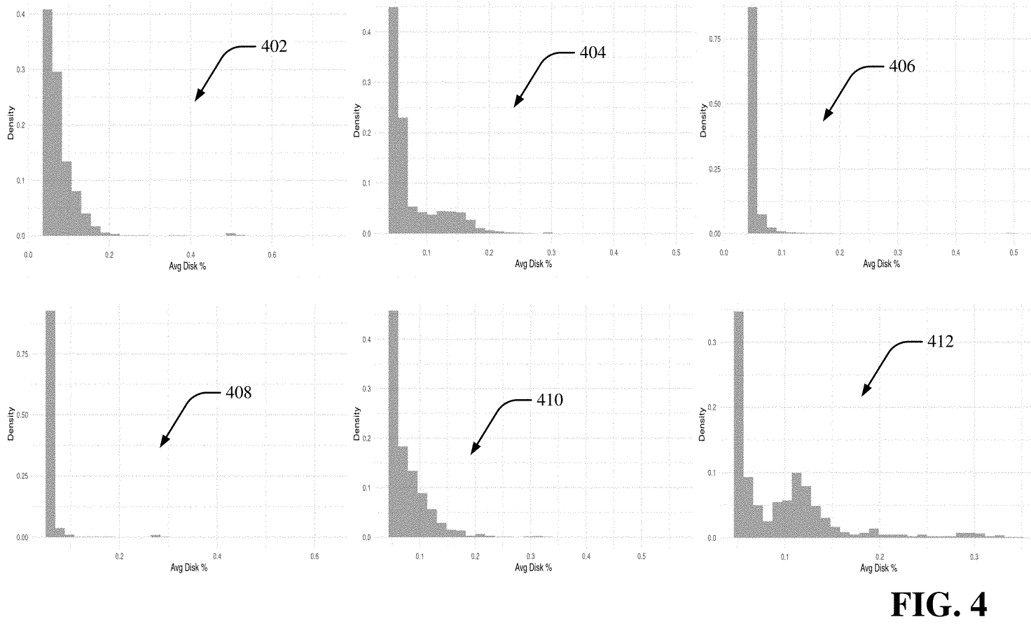

As the present inventors recognized, different object store workloads can have different resource utilization descriptors. Non-limiting examples of such variation in resource utilization descriptors are shown with respect to FIGS. 3-4.

FIGS. 3-4 illustrate example, non-limiting graphs showing variation in utilization of different resources in accordance with one or more embodiments described herein.

More specifically, FIG. 3 shows example, non-limiting probability density distributions of CPU utilizations for six different object store workloads. In particular, a first example and non-limiting object store workload can be associated with a first set of CPU utilizations (e.g., like the set of CPU utilizations 202), and the graph 302 shows a probability density distribution computed over such first set of CPU utilizations. Moreover, a second example and non-limiting object store workload can be associated with a second set of CPU utilizations (e.g., like the set of CPU utilizations 202), and the graph 304 shows a probability density distribution computed over such second set of CPU utilizations. Furthermore, a third example and non-limiting object store workload can be associated with a third set of CPU utilizations (e.g., like the set of CPU utilizations 202), and the graph 306 shows a probability density distribution computed over such third set of CPU utilizations. Further still, a fourth example and non-limiting object store workload can be associated with a fourth set of CPU utilizations (e.g., like the set of CPU utilizations 202), and the graph 308 shows a probability density distribution computed over such fourth set of CPU utilizations. Moreover, a fifth example and non-limiting object store workload can be associated with a fifth set of CPU utilizations (e.g., like the set of CPU utilizations 202), and the graph 310 shows a probability density distribution computed over such fifth set of CPU utilizations. Finally, a sixth example and non-limiting object store workload can be associated with a sixth set of CPU utilizations (e.g., like the set of CPU utilizations 202), and the graph 312 shows a probability density distribution computed over such sixth set of CPU utilizations.

As shown by the graph 302, the first example and non-limiting object store workload has the bulk of its CPUs being operated at and/or around about 20% capacity. As shown by the graph 304, the second example and non-limiting object store workload has the bulk of its CPUs being operated near 0% capacity (e.g., sitting idle) but also has a significant proportion of CPUs operating in the range of 20% to 50% capacity. As shown by the graph 306, the third example and non-limiting workload has the vast majority of its CPUs sitting idle. As shown by the graph 308, the fourth example and non-limiting object-store workload has the bulk of its CPUs operating near 12% percent capacity. As shown by the graph 310, the fifth example and non-limiting object store workload has the bulk of its CPUs operating near full capacity. Lastly, as shown by the graph 312, the sixth example and non-limiting object store workload has a significant proportion of CPUs sitting idle, a significant proportion of CPUs operating at about 20% capacity, and a significant proportion of CPUs operating between 50% and 60% capacity. These graphs help to illustrate how different object store workloads can exhibit different resource utilizations, at least with respect to CPUs.

Moving on, FIG. 4 shows example, non-limiting probability density distributions of permanent memory disk utilizations for the six above-mentioned object store workloads. In particular, the first example and non-limiting object store workload can be associated with a first set of disk utilizations (e.g., like the set of permanent memory disk utilizations 204), and the graph 402 shows a probability density distribution computed over such first set of disk utilizations. Moreover, the second example and non-limiting object store workload can be associated with a second set of disk utilizations (e.g., like the set of permanent memory disk utilizations 204), and the graph 404 shows a probability density distribution computed over such second set of disk utilizations. Furthermore, the third example and non-limiting object store workload can be associated with a third set of disk utilizations (e.g., like the set of permanent memory disk utilizations 204), and the graph 406 shows a probability density distribution computed over such third set of disk utilizations. Further still, the fourth example and non-limiting object store workload can be associated with a fourth set of disk utilizations (e.g., like the set of permanent memory disk utilizations 204), and the graph 408 shows a probability density distribution computed over such fourth set of disk utilizations. Moreover, the fifth example and non-limiting object store workload can be associated with a fifth set of disk utilizations (e.g., like the set of permanent memory disk utilizations 204), and the graph 410 shows a probability density distribution computed over such fifth set of disk utilizations. Finally, the sixth example and non-limiting object store workload can be associated with a sixth set of disk utilizations (e.g., like the set of permanent memory disk utilizations 204), and the graph 412 shows a probability density distribution computed over such sixth set of disk utilizations.

As shown by the graphs 402, 404, and 410, the first, second, and fifth example and non-limiting object store workloads have the bulk of their disks (e.g., HDDs, SSDs) being operated at near idle and/or otherwise below 20% capacity. As shown by the graphs 406 and 408, the third and fourth example and non-limiting object store workloads have the bulk of their disks being operated almost entirely near 0% capacity and/or otherwise under 10% capacity. Lastly, as shown by the graph 412, the sixth example and non-limiting workload has the vast majority of its disks sitting idle but also has a significant proportion of disks operating around 12% capacity. As above, these graphs help to illustrate how different object store workloads can exhibit different resource utilizations, at least with respect to permanent memory disks.

Those having ordinary skill in the art will appreciate that, although not explicitly shown in the figures, analogous graphs to those shown in FIGS. 3-4 can be generated showing how different object store workloads can have varying and/or different temporary memory utilizations and/or network bandwidth utilizations.

Furthermore, although the herein disclosure mainly describes various embodiments of the resource utilization descriptor 106 as including CPU utilizations, permanent memory disk utilizations, temporary memory utilizations, and/or network bandwidth utilizations, this is a mere non-limiting example for ease of explanation. In various aspects, the resource utilization descriptor 106 can include any suitable information pertaining to any other suitable computing resource of the object store 104 as desired. For example, in some cases, the resource utilization descriptor 106 can include any suitable information and/or metrics pertaining to any suitable counter manager (CM) objects of the object store 104. Non-limiting examples of CM objects of the object store 104 can include disks of the object store 104, raids of the object store 104, processors of the object store 104, systems of the object store 104, and/or waft of the object store 104. Non-limiting examples of information and/or metrics pertaining to a CM object can include total number of transfers performed with respect to the CM object, total number of reads performed with respect to the CM object, total number of writes performed with respect to the CM object, read operation latency associated with the CM object, and/or write operation latency associated with the CM object. In some instances, the resource utilization descriptor 106 can include any suitable measurable platform characteristics associated with the object store 104, such as hardware model numbers associated with the object store 104 and/or software version numbers associated with the object store 104. In various cases, the resource utilization descriptor 106 can include any suitable environmental metrics associated with the object store 104, such as CPU temperatures, CPU voltages, CPU currents, CPU power consumptions, disk temperatures, disk voltages, disk currents, and/or disk power consumptions.

Referring back to FIG. 1, in any case, the resource utilization descriptor 106 can be considered as conveying how a given workload of the object store 104 consumes and/or otherwise utilizes the computing resources of the object store 104, and it can be desired to classify that given workload of the object store 104 based on the resource utilization descriptor 106. As described herein, the object store workload classification system 102 can facilitate such classification.

In various embodiments, the object store workload classification system 102 can comprise a processor 108 (e.g., computer processing unit, microprocessor) and a computer-readable memory 110 that is operably connected/coupled to the processor 108. The memory 110 can store computer-executable instructions which, upon execution by the processor 108, can cause the processor 108 and/or other components of the object store workload classification system 102 (e.g., access component 112, model component 114, and/or execution component 116) to perform one or more acts. In various embodiments, the memory 110 can store computer-executable components (e.g., access component 112, model component 114, and/or execution component 116), and the processor 108 can execute the computer-executable components.

In various embodiments, the object store workload classification system 102 can comprise an access component 112. In various aspects, the access component 112 can electronically receive, retrieve, obtain, and/or otherwise access the resource utilization descriptor 106. In some cases, the access component 112 can electronically retrieve the resource utilization descriptor 106 from any suitable computing device (not shown) as desired. In other cases, the access component 112 can electronically retrieve the resource utilization descriptor 106 from the object store 104 itself. In any case, the access component 112 can electronically access the resource utilization descriptor 106, such that other components of the object store workload classification system 102 can electronically interact with the resource utilization descriptor 106.

In various embodiment, the object store workload classification system 102 can further comprise a model component 114. In various aspects, as described herein, the model component 114 can electronically execute a machine learning model on the resource utilization descriptor 106, so as to generate a classification label for the resource utilization descriptor 106. In various cases, the classification label can be considered as describing, qualifying, and/or otherwise characterizing the given workload of the object store 104 (e.g., can be considered as identifying a type and/or category of class to which the workload of the object store 104 belongs).

In various embodiments, the object store workload classification system 102 can further comprise an execution component. In various instances, as described herein, the execution component can electronically generate, transmit, and/or render any suitable warnings and/or recommendations pertaining to the object store 104, based on the classification label.

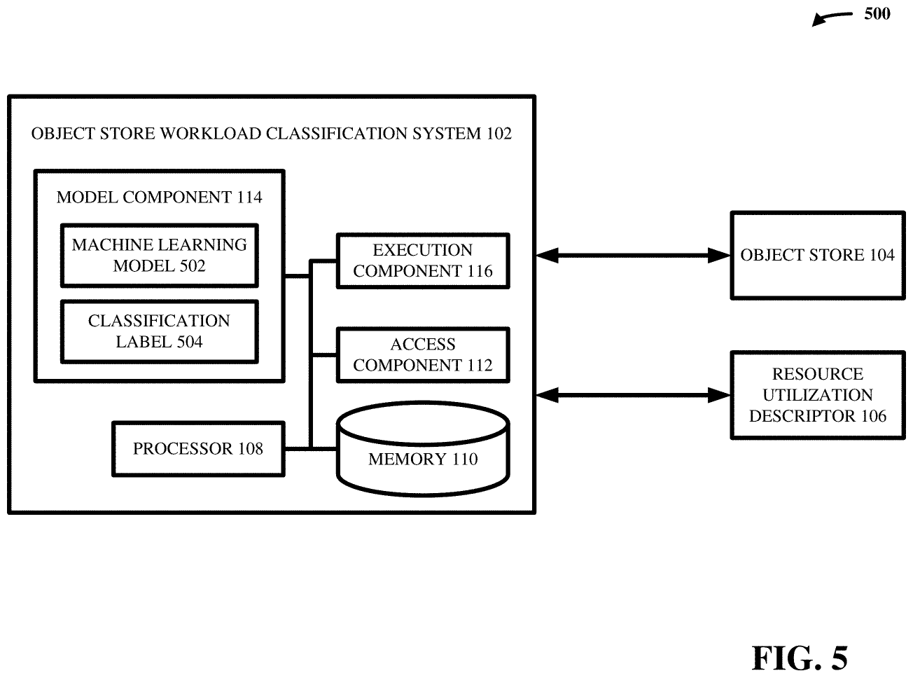

FIG. 5 illustrates a block diagram of an example, non-limiting system 500 including a machine learning model and a classification label that can facilitate machine learning classification of object store workloads in accordance with one or more embodiments described herein. As shown, the system 500 can, in some cases, comprise the same components as the system 100, and can further comprise a machine learning model 502 and/or a classification label 504.

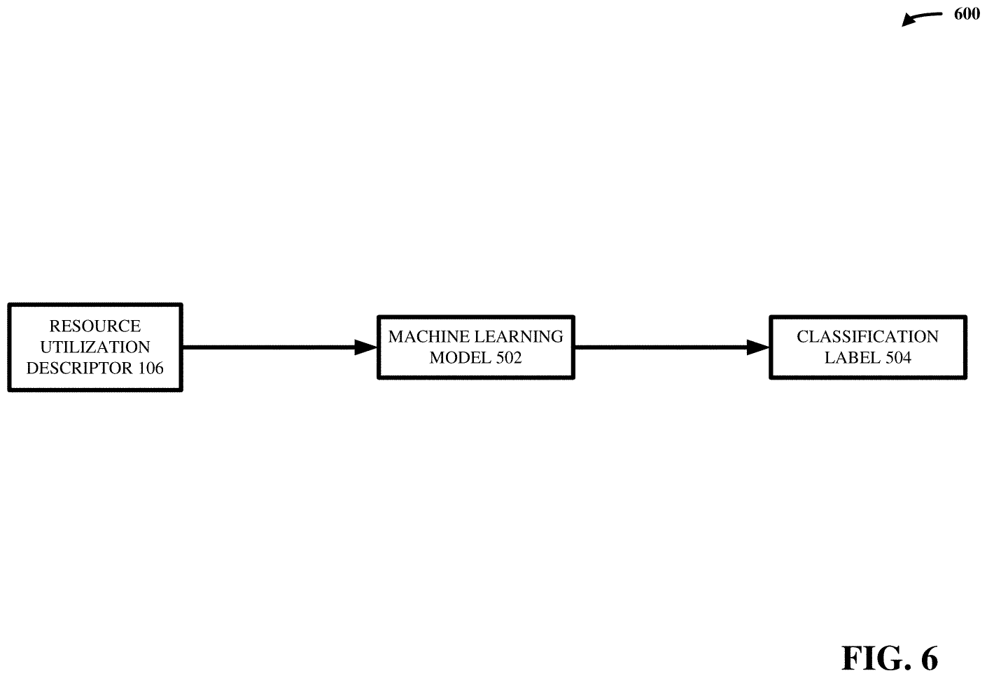

In various aspects, the model component 114 can electronically store, electronically maintain, electronically control, and/or otherwise electronically access the machine learning model 502. In various instances, the model component 114 can electronically execute the machine learning model 502 on the resource utilization descriptor 106, thereby yielding the classification label 504. This is further explained with respect to FIG. 6.

FIG. 6 illustrates an example, non-limiting block diagram 600 showing how the machine learning model 502 can generate the classification label 504 based on the resource utilization descriptor 106 in accordance with one or more embodiments described herein.

In various aspects, the machine learning model 502 can have any suitable artificial intelligence architecture as desired. For example, in some cases, the machine learning model 502 can have a deep learning neural network architecture. In such case, the machine learning model 502 can have any suitable number of neural network layers, any suitable numbers of neurons in various neural network layers, any suitable activation functions in various neurons, and/or any suitable interneuron connectivity patterns. As another example, in other cases, the machine learning model 502 can have a random forest architecture. In such case, the machine learning model 502 can be an ensemble of any suitable number of decision trees, with each decision tree having any suitable number of decision nodes, any suitable decision thresholds in various decision nodes, any suitable number of leaf nodes, and/or any suitable classification thresholds in various leaf nodes. Other non-limiting examples of artificial intelligence architectures that can be exhibited by the machine learning model 502 include support vector machine architectures, linear regression architectures, logistic regression architectures, k-means clustering architectures, and/or naïve Bayes architectures.

No matter the specific artificial intelligence architecture exhibited by the machine learning model 502, the machine learning model 502 can, in various aspects, be configured to receive as input the resource utilization descriptor 106 and to produce as output the classification label 504. For example, if the machine learning model 502 is a deep learning neural network, then the resource utilization descriptor 106 can be received by an input layer of the machine learning model 502, the resource utilization descriptor 106 can complete a forward pass through one or more hidden layers of the machine learning model 502, and an output layer of the machine learning model 502 can calculate the classification label 504 based on activation maps provided by the one or more hidden layers. As another example, if the machine learning model 502 is instead a random forest model, then the resource utilization descriptor 106 can be inputted into a root node of each decision tree of the machine learning model 502, the resource utilization descriptor 106 can pass through the decision node branches of each decision tree, a leaf node of each decision tree can classify the resource utilization descriptor 106, and the average of all of such decision tree classifications can be considered as the classification label 504.

In various aspects, the classification label 504 can be any suitable piece of electronic data (e.g., can be one or more scalars, one or more vectors, one or more matrices, one or more tensors, one or more character strings, and/or any suitable combination thereof) that characterizes, describes, and/or otherwise qualifies the resource utilization descriptor 106 (e.g., that characterizes, describes, and/or otherwise qualifies the object store workload that is represented by the resource utilization descriptor 106).

As a non-limiting example, the classification label 504 can, in some cases, indicate and/or convey what type and/or category of object store workload is represented by the resource utilization descriptor 106. For instance, a potential type/category of object store workload can be an electronic design automation type/category. The object store workload of an entity and/or institution that develops (e.g., via computer-aided design tools) and/or otherwise tests (e.g., via computerized simulations such as computational fluid dynamics and/or finite element analysis) product designs can be considered as belonging to such type/category. Another potential type/category of object store workload can be a financial services type/category. The object store workload of an entity and/or institution that facilitates and/or processes electronic financial transactions (e.g., such as electronically depositing currency into a financial account, electronically withdrawing currency from a financial account, and/or electronically validating a financial instrument such as a credit card) can be considered as belonging to such type/category. Yet another potential type/category of object store workload can be a retail services type/category. The object store workload of an entity and/or institution that sells products online and/or that otherwise facilitates delivery, inventory, and/or supply chain logistics for such products can be considered as belonging to such type/category. In any of such cases, the machine learning model 502 can be considered as being able to accurately infer a type/category of the object store workload that is represented by the resource utilization descriptor 106, and the classification label 504 can indicate such type/category.

As another non-limiting example, the classification label 504 can, in various aspects, indicate and/or convey a computing error, fault, and/or anomaly that is afflicting the object store 104 and/or that is otherwise afflicting the object store workload represented by the resource utilization descriptor 106. For instance, such computing errors, faults, and/or anomalies can include any suitable runtime errors (e.g., problems that prevent an application that is hosted in the object store 104 from being executed), any suitable compilation errors (e.g., problems that prevent an application that is hosted in the object store 104 from being compiled), any suitable syntax errors (e.g., instances where an application that is hosted in the object store 104 has been incorrectly coded), any suitable interface errors (e.g., instances where an application that is hosted in the object store 104 is receiving improperly formatted input data), any suitable resource errors (e.g., instances where a resource of the object store 104 is out of capacity), and/or any suitable arithmetic errors (e.g., instances where an application that is hosted in the object store 104 is attempting to perform mathematically impossible and/or intractable computations). In any of such cases, the machine learning model 502 can be considered as being able to accurately infer and/or detect a computing fault, error, and/or anomaly of the object store workload that is represented by the resource utilization descriptor 106, and the classification label 504 can indicate such computing fault, error, and/or anomaly.

As yet another non-limiting example, the classification label 504 can, in various instances, indicate and/or convey a computing resource of the object store 104 that is being overutilized and/or underutilized by the object store workload represented by the resource utilization descriptor 106. For instance, the classification label 504 can indicate and/or convey that one or more particular CPUs of the object store 104 are being overworked (e.g., are being operated on average within any suitable threshold of maximum capacity) by the workload represented by the resource utilization descriptor 106, and/or the classification label 504 can instead indicate that one or more particular CPUs of the object store 104 are being underworked (e.g., are being operated on average within any suitable threshold of idle) by the workload represented by the resource utilization descriptor 106. Moreover, the classification label 504 can, in various cases, indicate and/or convey that one or more particular HDDs and/or SSDs of the object store 104 are being overworked (e.g., are being operated on average within any suitable threshold of maximum capacity) by the workload represented by the resource utilization descriptor 106, and/or the classification label 504 can instead indicate that one or more particular HDDs and/or SSDs of the object store 104 are being underworked (e.g., are being operated on average within any suitable threshold of idle) by the workload represented by the resource utilization descriptor 106. Likewise, the classification label 504 can, in various aspects, indicate and/or convey that one or more particular RAMs of the object store 104 are being overworked (e.g., are being operated on average within any suitable threshold of maximum capacity) by the workload represented by the resource utilization descriptor 106, and/or the classification label 504 can instead indicate that one or more particular RAMs of the object store 104 are being underworked (e.g., are being operated on average within any suitable threshold of idle) by the workload represented by the resource utilization descriptor 106. Similarly, the classification label 504 can, in various instances, indicate and/or convey that one or more particular network communication channels of the object store 104 are being overworked (e.g., are being operated on average within any suitable threshold of maximum capacity) by the workload represented by the resource utilization descriptor 106, and/or the classification label 504 can instead indicate that one or more particular network communication channels of the object store 104 are being underworked (e.g., are being operated on average within any suitable threshold of idle) by the workload represented by the resource utilization descriptor 106. In any of such cases, the machine learning model 502 can be considered as being able to accurately infer and/or detect a computing resource of the object store 104 that is being overused and/or underused by the workload represented by the resource utilization descriptor 106, and the classification label 504 can indicate and/or identify such computing resource.

As still another non-limiting example, the classification label 504 can, in various cases, indicate and/or convey whether or not the workload represented by the resource utilization descriptor 106 can be successfully transplanted into an object store that is different (e.g., differently designed and/or differently configured) than the object store 104. As mentioned above, different object stores can be configured, designed, structured, and/or built to handle different types and/or volumes of workloads. More specifically, different object stores can have different numbers and/or types of CPUs and thus can have different processing capacities. Moreover, different object stores can have different numbers and/or types of HDDs/SSDs and thus can have different permanent memory disk capacities. Furthermore, different object stores can have different numbers and/or types of RAMs and thus can have different temporary memory capacities. Further still, different object stores can have different numbers and/or types of network communication channels and thus can have different network bandwidth capacities. In any of such cases, the machine learning model 502 can be considered as being able to accurately infer whether the workload represented by the resource utilization descriptor 106 could be transplanted into a particular object store, where such particular object store is designed, structured, and/or built differently than the object store 104, and the classification label 504 can indicate such inference (e.g., can indicate whether or not such transplantation would be successful).

In any case, the model component 114 can generate the classification label 504, by executing the machine learning model 502 on the resource utilization descriptor 106.

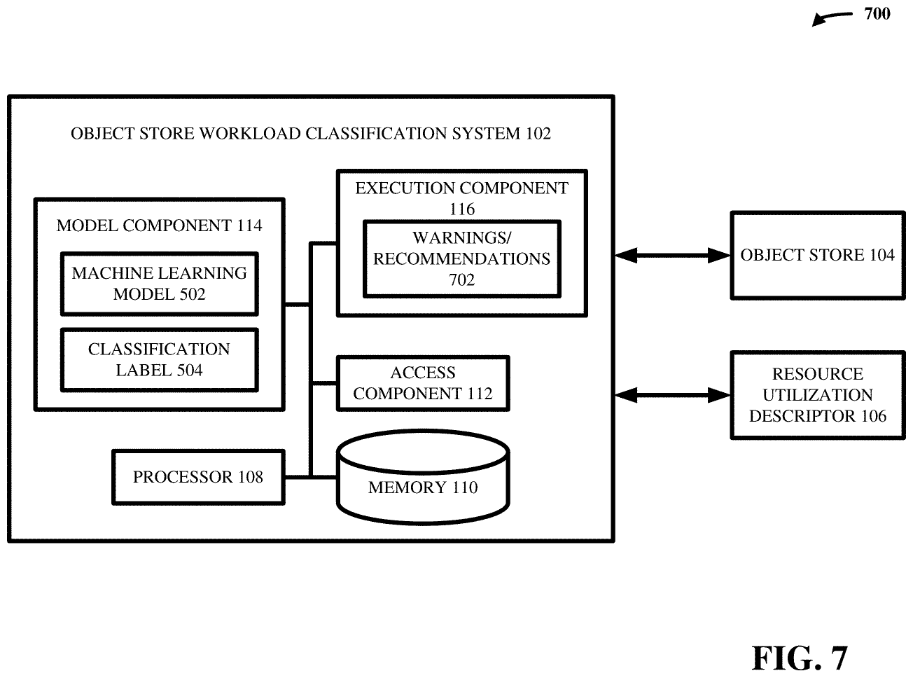

FIG. 7 illustrates a block diagram of an example, non-limiting system 700 including a set of warnings/recommendations that can facilitate machine learning classification of object store workloads in accordance with one or more embodiments described herein. As shown, the system 700 can, in some cases, comprise the same components as the system 500, and can further comprise one or more warnings/recommendations 702.

In various embodiments, the execution component 116 can electronically generate the one or more warnings/recommendations 702 based on the classification label 504. More specifically, the one or more warnings/recommendations 702 can be any suitable electronic messages, and the contents of such messages can be based on the classification label 504.

For example, suppose that the classification label 504 indicates and/or conveys a type/category of the object store workload represented by the resource utilization descriptor 106. In such case, the one or more warnings/recommendations 702 can pertain to such type/category. For instance, if the classification label 504 indicates that the object store workload represented by the resource utilization descriptor 106 belongs to an electronic design automation type/category, and if previous object store workloads known to belong to such electronic design automation type/category tended to suffer from a particular computing anomaly, then the one or more warnings/recommendations 702 can indicate that the object store workload represented by the resource utilization descriptor 106 might be vulnerable to that particular computing anomaly. Thus, the execution component 116 can electronically transmit the one or more warnings/recommendations 702 to a client device (not shown) associated with the resource utilization descriptor 106, so as to notify the client device of the potential vulnerability to the particular computing fault. As another non-limiting instance, if the classification label 504 indicates that the object store workload represented by the resource utilization descriptor 106 belongs to a financial services type/category, and if previous object store workloads known to belong to such financial services type/category tended to undergo a particular software update (e.g., a particular security enhancement), then the one or more warnings/recommendations 702 can suggest that the object store workload represented by the resource utilization descriptor 106 should also undergo that particular software update. Thus, the execution component 116 can electronically transmit the one or more warnings/recommendations 702 to a client device (not shown) associated with the resource utilization descriptor 106, so as to notify the client device of the particular software update.

As another example, suppose that the classification label 504 indicates and/or conveys a computing error, fault, and/or anomaly that is afflicting the object store 104 and/or that is afflicting the object store workload represented by the resource utilization descriptor 106. In such case, the one or more warnings/recommendations 702 can pertain to such computing error, fault, and/or anomaly. For instance, if the classification label 504 indicates that the object store workload represented by the resource utilization descriptor 106 suffers from a particular memory error, then the one or more warnings/recommendations 702 can indicate that such particular memory error has been detected. Thus, the execution component 116 can electronically transmit the one or more warnings/recommendations to a client device (not shown) associated with the resource utilization descriptor 106, so as to notify the client device that the particular memory error has been detected. As another non-limiting instance, if the classification label 504 indicates that the object store workload represented by the resource utilization descriptor 106 suffers from a particular runtime error, and if previous object store workloads have successfully solved such particular runtime error via a specific remedial action, then the one or more warnings/recommendations 702 can indicate that such particular runtime error has been detected and that such particular runtime error might be solvable by the specific remedial action. Thus, the execution component 116 can electronically transmit the one or more warnings/recommendations 702 to a client device (not shown) associated with the resource utilization descriptor 106, so as to notify the client device that the particular runtime error has been detected and/or so as to notify the client device of the specific remedial action.

As yet another example, suppose that the classification label 504 indicates and/or conveys that one or more resources of the object store 104 are being overutilized and/or underutilized by the object store workload represented by the resource utilization descriptor 106. In such case, the one or more warnings/recommendations 702 can pertain to such overutilized and/or underutilized resources. For instance, if the classification label 504 indicates that a particular resource of the object store 104 is being overutilized by the object store workload represented by the resource utilization descriptor 106, then the one or more warnings/recommendations 702 can indicate that such particular resource is being overutilized. Thus, the execution component 116 can electronically transmit the one or more warnings/recommendations 702 to a client device (not shown) associated with the resource utilization descriptor 106, so as to notify the client device that overutilization of the particular resource has been detected. As another non-limiting instance, if the classification label 504 indicates that a particular resource of the object store 104 is being overutilized by the object store workload represented by the resource utilization descriptor 106, and if previous object store workloads have successfully decreased such overutilization by implementing a particular workload adjustment, then the one or more warnings/recommendations 702 can indicate that such particular resource is being overutilized and that the particular workload adjustment might help to reduce such overutilization. Thus, the execution component 116 can electronically transmit the one or more warnings/recommendations 702 to a client device (not shown) associated with the resource utilization descriptor 106, so as to notify the client device that overutilization of the particular resource has been detected, and/or so to notify the client device that the particular workload adjustment might help to reduce such overutilization.

As still another example, suppose that the classification label 504 indicates and/or conveys whether or not the workload represented by the resource utilization descriptor 106 could be successfully and/or appropriately transplanted into a particular object store that is different from the object store 104. In such case, the one or more warnings/recommendations 702 can pertain to such transplantation. For instance, if the classification label 504 indicates that the workload represented by the resource utilization descriptor 106 could be successfully and/or appropriately transplanted into a particular object store that is different from the object store 104, then the one or more warnings/recommendations 702 can indicate that such transplantation would be successful and/or can otherwise suggest that such transplantation should be carried out. On the other hand, if the classification label 504 indicates that the workload represented by the resource utilization descriptor 106 could not be successfully and/or appropriately transplanted into the particular object store that is different from the object store 104, then the one or more warnings/recommendations 702 can indicate that such transplantation would be unsuccessful and/or can otherwise suggest that such transplantation should not be carried out. In any case, the execution component 116 can transmit the one or more warnings/recommendations 702 to a client device (not shown) associated with the resource utilization descriptor 106, so as to notify the client device whether or not such transplantation would be successful.

Although the herein disclosure mainly describes the execution component 116 as electronically transmitting the one or more warnings/recommendations 702 to one or more client devices, this is a mere non-limiting example. In various cases, the execution component 116 can electronically render, on any suitable computer displays/screens/monitors, the one or more warnings/recommendations 702.

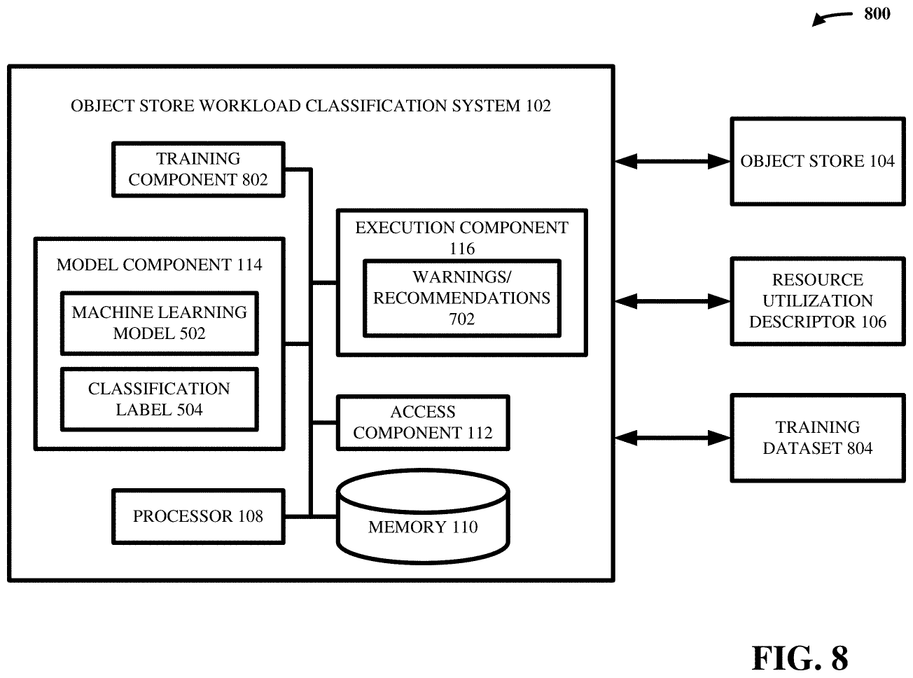

As mentioned above, the machine learning model 502 can be configured to receive as input the resource utilization descriptor 106 and to produce as output the classification label 504. In order to facilitate such functionality, the machine learning model 502 should first be trained. In various cases, the machine learning model 502 can be trained in a supervised fashion, as described with respect to FIGS. 8-10.

FIG. 8 illustrates a block diagram of an example, non-limiting system 800 including a training component and a training dataset that can facilitate machine learning classification of object store workloads in accordance with one or more embodiments described herein. As shown, the system 800 can, in some cases, comprise the same components as the system 700, and can further comprise a training component 802 and/or a training dataset 804.

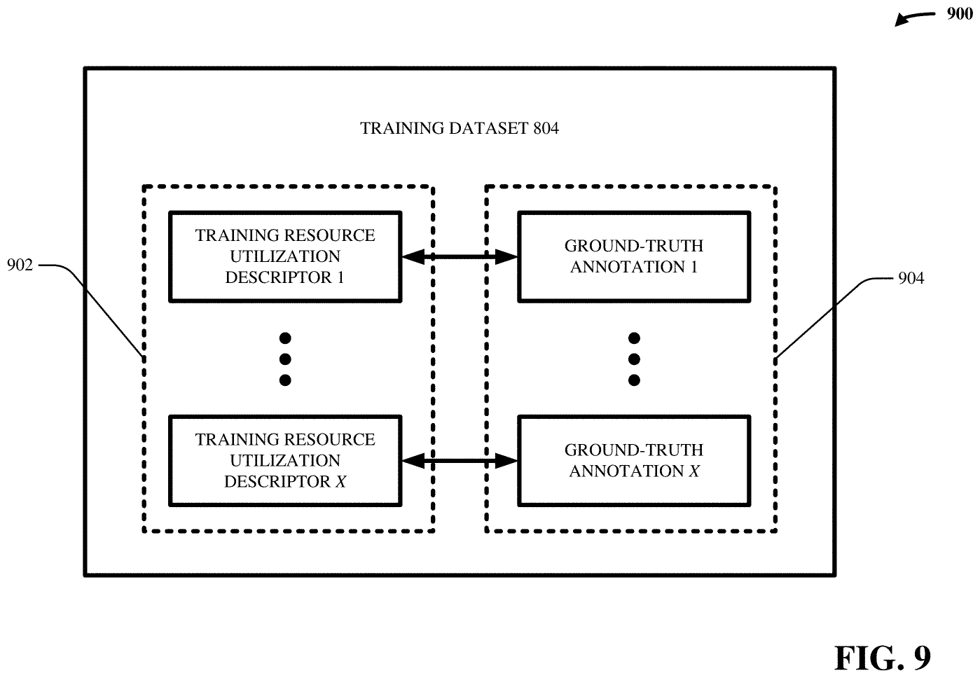

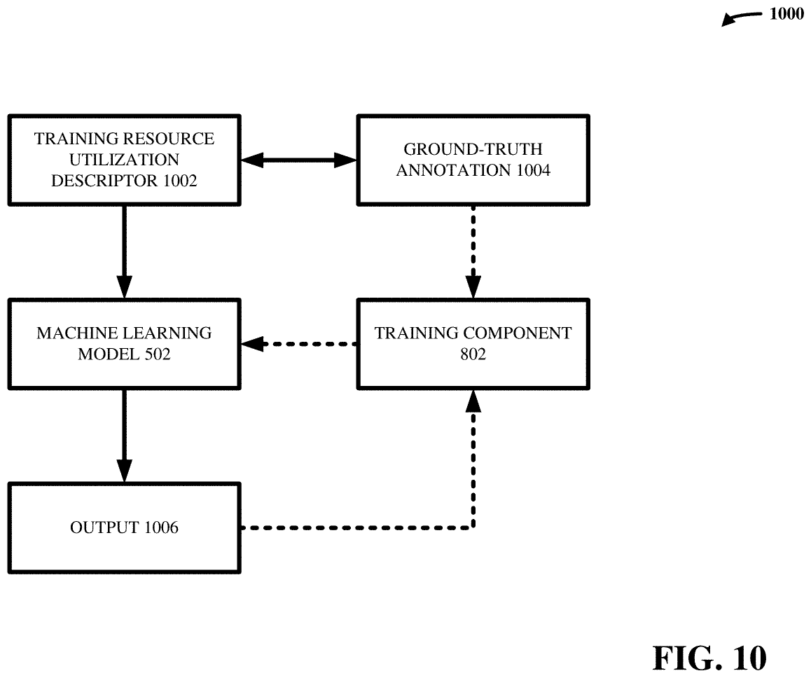

In various embodiments, the access component 112 can electronically receive, retrieve, and/or otherwise access the training dataset 804 from any suitable source (not shown), and the training component 802 can electronically train the machine learning model 502 on the training dataset 804. This is described more with respect to FIGS. 9-10.

FIG. 9 illustrates an example, non-limiting block diagram showing a training dataset in accordance with one or more embodiments described herein. In other words, FIG. 9 shows a non-limiting example embodiment of the training dataset 804.

In various embodiments, the training dataset 804 can include a set of training resource utilization descriptors 902 and a set of ground-truth annotations 904 that respectively correspond to the set of training resource utilization descriptors 902.

In various aspects, the set of training resource utilization descriptors 902 can include x descriptors for any suitable positive integer x: a training resource utilization descriptor 1 to a training resource utilization descriptor x. In various instances, each of the set of training resource utilization descriptors 902 can have the same format and/or dimensionality as the resource utilization descriptor 106. For example, the training resource utilization descriptor 1 can be one or more scalars, vectors, matrices, tensors, and/or character strings that represent utilizations of various resources (e.g., CPUs, permanent memory disks, temporary memory, and/or network communication channels) of an object store when such object store is subjected to a first object store workload. Similarly, the training resource utilization descriptor x can be one or more scalars, vectors, matrices, tensors, and/or character strings that represent utilizations of various resources (e.g., CPUs, permanent memory disks, temporary memory, and/or network communication channels) of an object store when such object store is subjected to an x-th object store workload.

In various aspects, the set of ground-truth annotations 904 can respectively correspond in one-to-one fashion to the set of training resource utilization descriptors 902. That is, the set of ground-truth annotations 904 can include x annotations: a ground-truth annotation 1 to a ground-truth annotation x. In various instances, each ground-truth annotation can be, convey, and/or otherwise represent a correct and/or accurate classification label for a respectively corresponding training resource utilization descriptor. For example, the ground-truth annotation 1 can correspond to the training resource utilization descriptor 1, and thus the ground-truth annotation 1 can represent the correct classification label that is known and/or deemed to correspond to the training resource utilization descriptor 1. Likewise, the ground-truth annotation x can correspond to the training resource utilization descriptor x, and thus the ground-truth annotation x can represent the correct classification label that is known and/or deemed to correspond to the training resource utilization descriptor x.

FIG. 10 illustrates an example, non-limiting block diagram 1000 showing how the machine learning model 502 can be trained based on the training dataset 804 in accordance with one or more embodiments described herein, specifically for a case in which the machine learning model 502 exhibits a neural network architecture.

In various embodiments, the internal parameters (e.g., weights and/or biases for a neural network) of the machine learning model 502 can be randomly initialized. In various aspects, the training component 802 can electronically select a training resource utilization descriptor 1002 and a corresponding ground-truth annotation 1004 from the training dataset 804.

In various instances, the training component 802 can electronically feed the training resource utilization descriptor 1002 as input to the machine learning model 502, and this can cause the machine learning model 502 to produce some output 1006. More specifically, an input layer of the machine learning model 502 can receive the training resource utilization descriptor 1002, the training resource utilization descriptor 1002 can complete a forward pass through one or more hidden layers of the machine learning model 502, and an output layer of the machine learning model 502 can compute the output 1006 based on activations provided by the one or more hidden layers. In various aspects, the output 1006 can be considered as representing the classification label which the machine learning model 502 infers and/or believes should correspond to the training resource utilization descriptor 1002. In contrast, the ground-truth annotation 1004 can be considered as the correct and/or accurate classification label that is known and/or deemed to correspond to the training resource utilization descriptor 1002. Note that, if the machine learning model 502 has so far undergone no and/or little training, then the output 1006 can be highly inaccurate (e.g., can be very different from the ground-truth annotation 1004). In any case, the training component 802 can compute an error/loss between the output 1006 and the ground-truth annotation 1004. Accordingly, the training component 802 can update, via backpropagation, the internal parameters of the machine learning model 502 based on such error/loss.

In various aspects, the training component 802 can repeat the above training procedure for each training resource utilization descriptor in the training dataset 804, with the ultimate result being that the internal parameters of the machine learning model 502 become iteratively optimized for accurately classifying inputted resource utilization descriptors. Those having ordinary skill in the art will appreciate that any suitable training batch sizes, any suitable training termination criteria, and/or any suitable error/loss functions can be implemented as desired.

Although FIG. 10 mainly pertains to situations in which the machine learning model 502 exhibits a neural network architecture, this is a mere non-limiting example for ease of illustration. In various other embodiments, the training component 802 can perform different types of supervised training, based on the architecture of the machine learning model 502.

For example, suppose that the machine learning model 502 exhibits a random forest architecture. In such case, the machine learning model 502 can include an ensemble of randomly-initialized decision trees, the training component can fit each of such ensemble of decision trees to the training dataset 804 via any suitable sample splitting techniques as desired (e.g., splitting the training dataset 804 according to ground-truth annotation based on estimate of positive correctness, splitting the training dataset 804 according to ground-truth annotation based on Gini impurity, splitting the training dataset 804 according to ground-truth annotation based on information gain, splitting the training dataset 804 according to ground-truth annotation based on variance reduction, splitting the training dataset 804 according to ground-truth annotation based on measure of “goodness”). Furthermore, in various instances, the training component 802 can perform any suitable pruning techniques as desired (e.g., reduced error pruning, cost complexity pruning) on each of such ensemble of decision trees after such sample splitting. In any case, the ultimate result can be that each of the ensemble of decision trees of the machine learning model 502 now has internal parameters (e.g., decision node locations, decision node thresholds, leaf node locations, and/or leaf node thresholds) that have been optimized to accurately classify inputted resource utilization descriptors.

Those having ordinary skill in the art will appreciate that analogous supervised training techniques can be implemented based on the architecture exhibited by the machine learning model 502 (e.g., supervised learning for linear regression, supervised learning for logistic regression, supervised learning for support vector machines, supervised learning naïve Bayes).

Although the herein disclosure mainly describes embodiments where the training dataset 804 is annotated and thus where the machine learning model 502 can be trained in supervised fashion, this is a mere non-limiting example for ease of explanation. Those having ordinary skill in the art will appreciate that, in various embodiments, the training dataset 804 can be unannotated (e.g., the set of ground-truth annotations 904 can be absent and/or unknown) and that, in such cases, the machine learning model 502 can instead be trained in any suitable unsupervised and/or reinforcement learning fashion as desired.

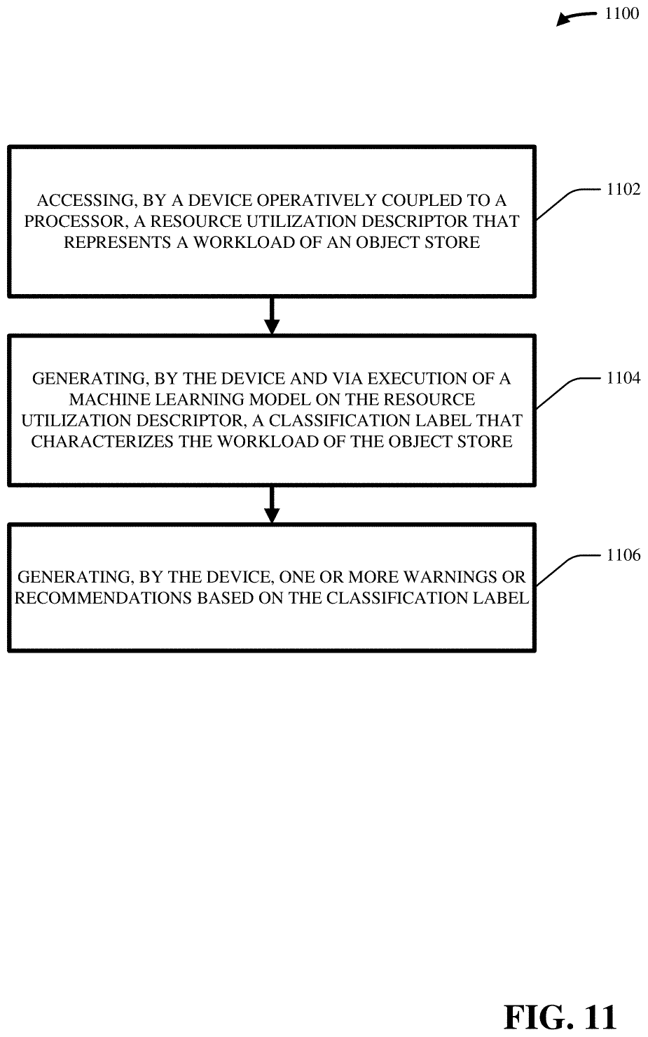

FIG. 11 illustrates a flow diagram of an example, non-limiting computer-implemented method 1100 that can facilitate machine learning classification of object store workloads in accordance with one or more embodiments described herein. In various cases, the object store workload classification system 102 can facilitate the computer-implemented method 1100.

In various embodiments, act 1102 can include accessing, by a device (e.g., via 112) operatively coupled to a processor, a resource utilization descriptor (e.g., 106) that represents a workload of an object store (e.g., 104).

In various aspects, act 1104 can include generating, by the device (e.g., via 114) and via execution of a machine learning model (e.g., 502) on the resource utilization descriptor, a classification label (e.g., 504) that characterizes the workload of the object store.

In various instances, act 1106 can include generating, by the device (e.g., via 116), one or more warnings or recommendations (e.g., 702) based on the classification label.

Although not explicitly shown in FIG. 11, the resource utilization descriptor can indicate at least one computer processing unit utilization level (e.g., 202) of the object store, at least one temporary computer memory utilization level (e.g., 206) of the object store, at least one permanent computer memory utilization level (e.g., 204) of the object store, and/or at least one network bandwidth utilization level (e.g., 208) of the object store.

Although not explicitly shown in FIG. 11, the classification label can identify a computing fault afflicting the workload of the object store, and the generating one or more warnings or recommendations can include transmitting, by the device (e.g., via 116) and to a client device, a warning (e.g., 702) that flags the computing fault or a recommendation (e.g., 702) for remedying the computing fault.

Although not explicitly shown in FIG. 11, the classification label can identify a resource of the object store that is being underutilized by the workload, and the generating one or more warnings or recommendations can include transmitting, by the device (e.g., via 116) and to a client device, a suggestion (e.g., 702) that utilization of such resource be increased.

Although not explicitly shown in FIG. 11, the classification label can indicate a resource of the object store that is being overutilized by the workload, and the generating one or more warnings or recommendations can include transmitting, by the device (e.g., via 116) and to a client device, a suggestion (e.g., 702) that utilization of such resource be decreased.

Although not explicitly shown in FIG. 11, the classification label can indicate that the workload could be successfully transplanted to a different object store, and the generating one or more warnings or recommendations can include transmitting, by the device (e.g., via 116) and to a client device, a recommendation (e.g., 702) that the workload should be transplanted to the different object store.

Although not explicitly shown in FIG. 11, the classification label can indicate that the workload could not be successfully transplanted to a different object store, and the generating one or more warnings or recommendations can include transmitting, by the device (e.g., via 116) and to a client device, a recommendation (e.g., 702) that the workload should not be transplanted to the different object store.

Although not explicitly shown in FIG. 11, the computer-implemented method 1100 can further comprise: accessing, by the device (e.g., via 112), a training dataset (e.g., 804) comprising a set of training resource utilization descriptors (e.g., 902); and training, by the device (e.g., via 802), the machine learning model on the training dataset.

Although not explicitly shown in FIG. 11, the machine learning model can, in some cases, be a deep learning neural network, the deep learning neural network can receive as input the resource utilization descriptor, and/or the deep learning neural network can produce as output the classification label. In other cases, the machine learning model can be a random forest model comprising an ensemble of decision trees, root nodes of the ensemble of decision trees can receive as input the resource utilization descriptor, leaf nodes of the ensemble of decision trees can generate preliminary classifications for the resource utilization descriptor, and the classification label can be based on an average of the preliminary classifications.

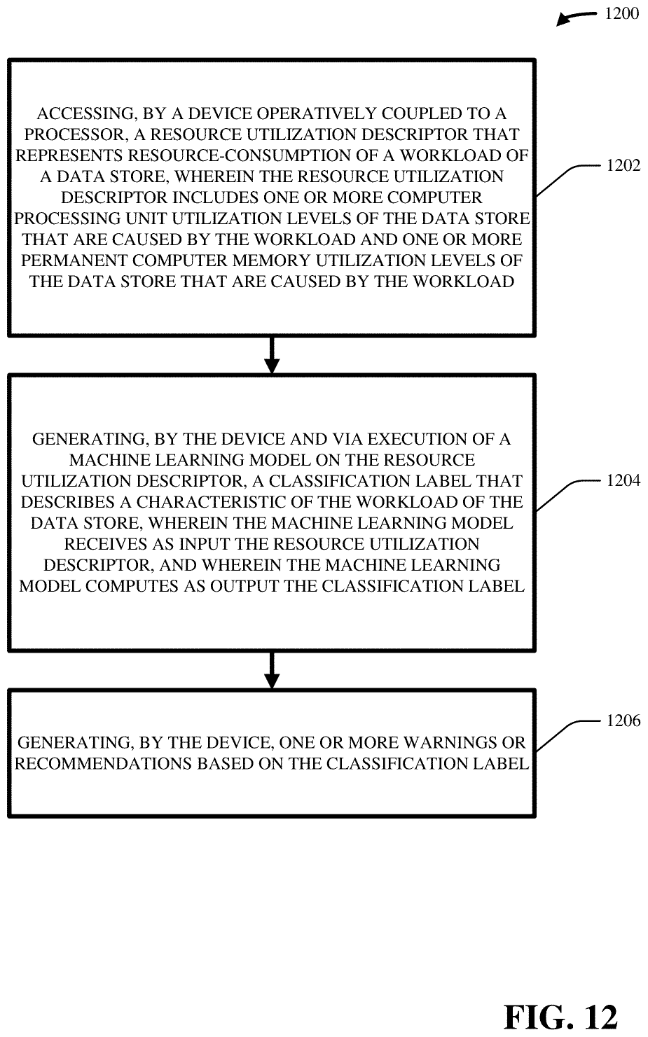

FIG. 12 illustrates a flow diagram of an example, non-limiting computer-implemented method 1200 that can facilitate machine learning classification of object store workloads in accordance with one or more embodiments described herein. In various cases, the object store workload classification system 102 can facilitate the computer-implemented method 1200.

In various embodiments, act 1202 can include accessing, by a device (e.g., via 112) operatively coupled to a processor, a resource utilization descriptor (e.g., 106) that represents resource-consumption of a workload of a data store (e.g., 104). In various cases, the resource utilization descriptor can include one or more computer processing unit utilization levels (e.g., 202) of the data store that are caused by the workload and/or one or more permanent computer memory utilization levels (e.g., 204) of the data store that are caused by the workload.

In various aspects, act 1204 can include generating, by the device (e.g., via 114) and via execution of a machine learning model (e.g., 502) on the resource utilization descriptor, a classification label (e.g., 504) that describes a characteristic of the workload of the data store. In various cases, the machine learning model can receive as input the resource utilization descriptor and/or can compute as output the classification label.

In various instances, act 1206 can include generating, by the device (e.g., via 116), one or more warnings and/or recommendations (e.g., 702) based on the classification label.

Although not explicitly shown in FIG. 12, the resource utilization descriptor can further include one or more temporary computer memory utilization levels (e.g., 206) of the data store that are caused by the workload and/or one or more network bandwidth utilization levels (e.g., 208) of the data store that are caused by the workload.

Although not explicitly shown in FIG. 12, the classification label can identify a computing fault afflicting the workload of the data store, and the generating one or more warnings or recommendations can include transmitting, by the device (e.g., via 116) and to a client device, a warning (e.g., 702) that flags the computing fault or a recommendation (e.g., 702) for remedying the computing fault.

Although not explicitly shown in FIG. 12, the classification label can identify a resource of the data store that is being underutilized by the workload, and the generating one or more warnings or recommendations can include transmitting, by the device (e.g., via 116) and to a client device, a suggestion (e.g., 702) that utilization of such resource be increased.

Although not explicitly shown in FIG. 12, the classification label can indicate a resource of the data store that is being overutilized by the workload, and the generating one or more warnings or recommendations can include transmitting, by the device (e.g., via 116) and to a client device, a suggestion (e.g., 702) that utilization of such resource be decreased.

Although not explicitly shown in FIG. 12, the classification label can indicate that the workload could be successfully transplanted to a different data store, and the generating one or more warnings or recommendations can include transmitting, by the device (e.g., via 116) and to a client device, a recommendation (e.g., 702) that the workload should be transplanted to the different data store.

Although not explicitly shown in FIG. 12, the classification label can indicate that the workload could not be successfully transplanted to a different data store, and the generating one or more warnings or recommendations can include transmitting, by the device (e.g., via 116) and to a client device, a recommendation (e.g., 702) that the workload should not be transplanted to the different data store.

Although not explicitly shown in FIG. 12, the computer-implemented method 1200 can further include: accessing, by the device (e.g., via 112), a training dataset (e.g., 804) comprising a set of training resource utilization descriptors (e.g., 902); and training, by the device (e.g., via 802), the machine learning model on the training dataset.

Accordingly, various embodiments described herein can include a computerized tool that can facilitate machine learning classification of object store workloads. In particular, such computerized tool can access a resource utilization descriptor representing a workload of an object store, can execute a machine learning model on such resource utilization descriptor, thereby yielding a classification label that characterizes the workload of the object store, and can electronically transmit and/or render any suitable warnings and/or recommendations pertaining to the workload of the object store based on the classification label. In this way, warnings and/or recommendations for the object store can be made in a less time-consuming fashion as compared to heuristic techniques, in a less subjective fashion as compared to heuristic techniques, and/or in a more targeted/tailored fashion as compared to heuristic techniques. Such a computerized tool certainly constitutes a useful and practical application of computers.

Although the herein disclosure mainly describes various embodiments as applying to object stores (e.g., 104), this is a mere non-limiting example. Those having ordinary skill in the art will appreciate that the herein-described teachings can be applied to any other suitable type of electronic data store as desired (e.g., such as electronic file storage systems and/or electronic block storage systems). In other words, the herein-described teachings are not limited to only object-oriented databases. In still other words, no matter the format of data that is stored by an electronic data storage platform (e.g., stored as objects, stored as files, stored as blocks, and/or stored in any other suitable type of format), various embodiments described herein can be applied to classify the workload of such electronic data storage platform.

In various instances, machine learning algorithms and/or models can be implemented in any suitable way to facilitate any suitable aspects described herein. To facilitate some of the above-described machine learning aspects of various embodiments of the subject innovation, consider the following discussion of artificial intelligence (AI). Various embodiments of the present innovation herein can employ artificial intelligence to facilitate automating one or more features of the present innovation. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) of the present innovation, components of the present innovation can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z₁, z₂, z₃, z₄, zₙ), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

Those having ordinary skill in the art will appreciate that the herein disclosure describes non-limiting examples of various embodiments of the subject innovation. For ease of description and/or explanation, various portions of the herein disclosure utilize the term “each” when discussing various embodiments of the subject innovation. Those having ordinary skill in the art will appreciate that such usages of the term “each” are non-limiting examples. In other words, when the herein disclosure provides a description that is applied to “each” of some particular object and/or component, it should be understood that this is a non-limiting example of various embodiments of the subject innovation, and it should be further understood that, in various other embodiments of the subject innovation, it can be the case that such description applies to fewer than “each” of that particular object and/or component.

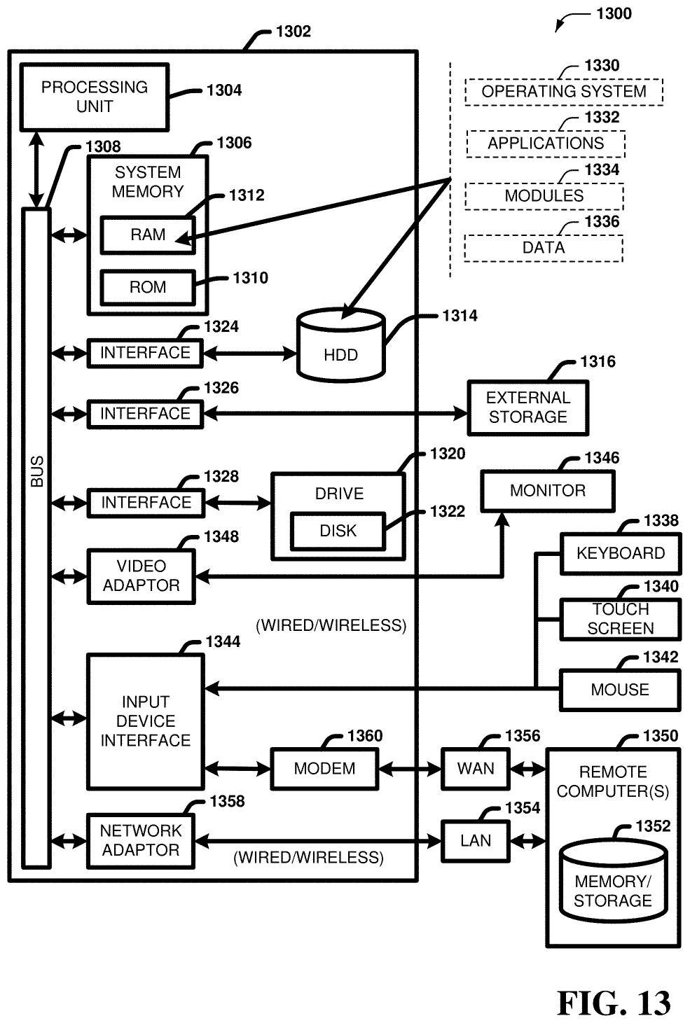

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and a drive 1320, e.g., such as a solid state drive, an optical disk drive, which can read or write from a disk 1322, such as a CD-ROM disc, a DVD, a BD, etc. Alternatively, where a solid state drive is involved, disk 1322 would not be included, unless separate. While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and drive 1320 can be connected to the system bus 1308 by an HDD interface 1324, an external storage interface 1326 and a drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above, such as but not limited to a network virtual machine providing one or more aspects of storage or processing of information. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

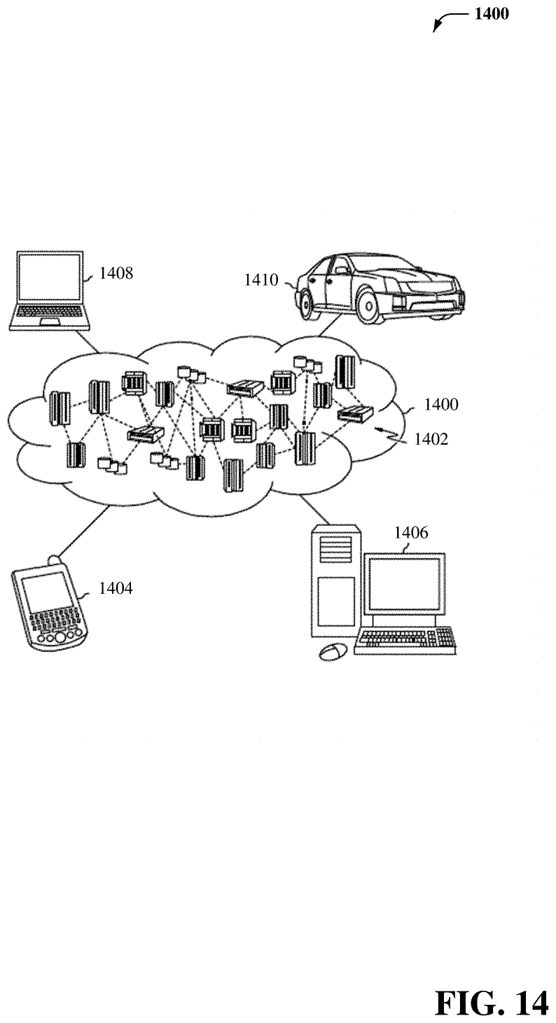

Referring now to FIG. 14, illustrative cloud computing environment 1400 is depicted. As shown, cloud computing environment 1400 includes one or more cloud computing nodes 1402 with which local computing devices used by cloud consumers, such as, for example, personal digital assistant (PDA) or cellular telephone 1404, desktop computer 1406, laptop computer 1408, and/or automobile computer system 1410 may communicate. Nodes 1402 may communicate with one another. They may be grouped (not shown) physically or virtually, in one or more networks, such as Private, Community, Public, or Hybrid clouds as described hereinabove, or a combination thereof. This allows cloud computing environment 1400 to offer infrastructure, platforms and/or software as services for which a cloud consumer does not need to maintain resources on a local computing device. It is understood that the types of computing devices 1404-1410 shown in FIG. 14 are intended to be illustrative only and that computing nodes 1402 and cloud computing environment 1400 can communicate with any type of computerized device over any type of network and/or network addressable connection (e.g., using a web browser).

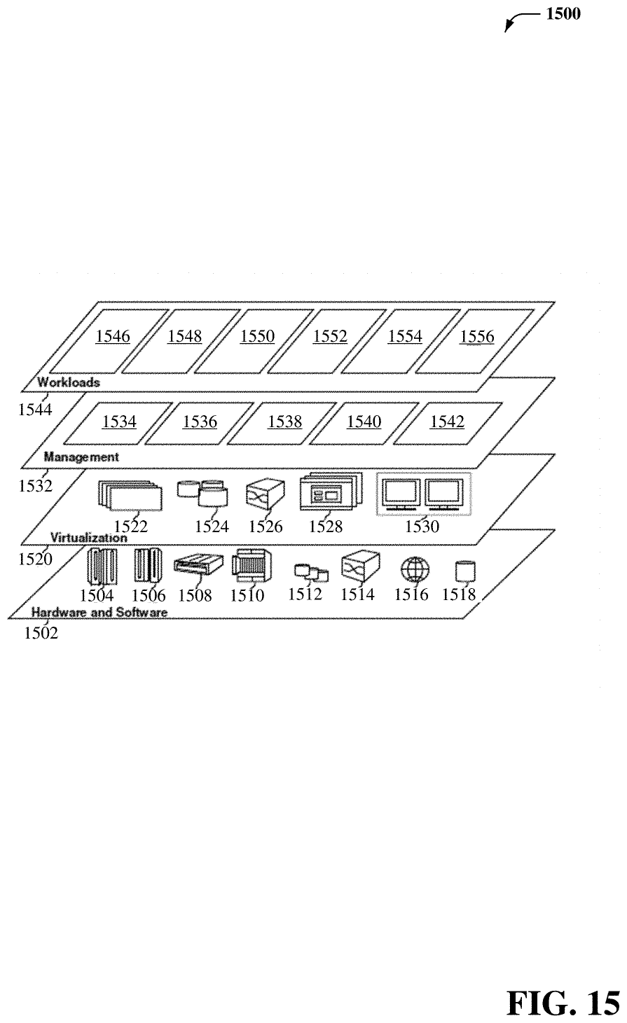

Referring now to FIG. 15, a set of functional abstraction layers provided by cloud computing environment 1400 (FIG. 14) is shown. Repetitive description of like elements employed in other embodiments described herein is omitted for sake of brevity. It should be understood in advance that the components, layers, and functions shown in FIG. 15 are intended to be illustrative only and embodiments described herein are not limited thereto. As depicted, the following layers and corresponding functions are provided.

Hardware and software layer 1502 includes hardware and software components. Examples of hardware components include: mainframes 1504; RISC (Reduced Instruction Set Computer) architecture based servers 1506; servers 1508; blade servers 1510; storage devices 1512; and networks and networking components 1514. In some embodiments, software components include network application server software 1516 and database software 1518.

Virtualization layer 1520 provides an abstraction layer from which the following examples of virtual entities may be provided: virtual servers 1522; virtual storage 1524; virtual networks 1526, including virtual private networks; virtual applications and operating systems 1528; and virtual clients 1530.

In one example, management layer 1532 may provide the functions described below. Resource provisioning 1534 provides dynamic procurement of computing resources and other resources that are utilized to perform tasks within the cloud computing environment. Metering and Pricing 1536 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1538 provides access to the cloud computing environment for consumers and system administrators. Service level management 1540 provides cloud computing resource allocation and management such that required service levels are met. Service Level Agreement (SLA) planning and fulfillment 1542 provide pre-arrangement for, and procurement of, cloud computing resources for which a future requirement is anticipated in accordance with an SLA.

Workloads layer 1544 provides examples of functionality for which the cloud computing environment may be utilized. Examples of workloads and functions which may be provided from this layer include: mapping and navigation 1546; software development and lifecycle management 1548; virtual classroom education delivery 1550; data analytics processing 1552; transaction processing 1554; and differentially private federated learning processing 1556. Various embodiments described herein can utilize the cloud computing environment described with reference to FIGS. 14 and 15 to execute one or more differentially private federated learning process in accordance with various embodiments described herein.

Various embodiments described herein may be a system, a method, an apparatus and/or a computer program product at any possible technical detail level of integration. The computer program product can include a computer readable storage medium (or media) having computer readable program instructions thereon for causing a processor to carry out aspects of various embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded (e.g., in on-box fashion and/or in off-box fashion) to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device. Computer readable program instructions for carrying out operations of various embodiments described herein can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of various embodiments described herein.

Aspects of various embodiments are described herein with reference to flowchart illustrations and/or block diagrams of methods, apparatus (systems), and computer program products according to various embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, and/or data structures, that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, nonvolatile random access memory (RAM) (e.g., ferroelectric RAM (FeRAM), and/or spinning disk drives. Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for generating machine learning classifications of data store workloads, comprising:
a processor that executes computer-executable components stored in a computer-readable memory, the computer-executable components comprising:
an access component that accesses a resource utilization descriptor representing how a workload of a data store consumes resources of the data store, wherein the resource utilization descriptor indicates at least one of a computer processing unit utilization level of the data store that is caused by the workload, a temporary computer memory utilization level of the data store that is caused by the workload, a permanent computer memory utilization level of the data store that is caused by the workload, or a network bandwidth utilization level of the data store that is caused by the workload;
a model component that generates, via execution of a machine learning model, a classification label based on the resource utilization descriptor, wherein the model component feeds the resource utilization descriptor as input to the machine learning model, wherein the machine learning model produces as output the classification label, and wherein the classification label characterizes the workload of the data store; and
an execution component that performs one or more electronic actions based on the classification label.

2. The system of claim 1, wherein the resource utilization descriptor indicates the computer processing unit utilization level of the data store that is caused by the workload, the temporary computer memory utilization level of the data store that is caused by the workload, the permanent computer memory utilization level of the data store that is caused by the workload, and the network bandwidth utilization level of the data store that is caused by the workload.

3. The system of claim 1, wherein the classification label indicates a computing fault of the data store that is related to the workload, and wherein the one or more electronic actions include transmitting to a client device associated with the workload a warning regarding the computing fault.

4. The system of claim 1, wherein the classification label indicates a computing fault of the data store that is related to the workload, and wherein the one or more electronic actions include transmitting to a client device associated with the workload a recommendation for remedying the computing fault.

5. The system of claim 1, wherein the classification label indicates one or more resources of the data store that are being underutilized or overutilized by the workload, and wherein the one or more electronic actions include transmitting to a client device associated with the workload a recommendation for remedying such underutilization or overutilization.

6. The system of claim 1, wherein the classification label indicates whether the workload could be successfully transplanted to a different data store, and wherein the one or more electronic actions include transmitting to a client device associated with the workload a recommendation regarding such transplantation.

7. The system of claim 1, wherein the access component accesses a training dataset comprising a set of annotated or unannotated training resource utilization descriptors, and wherein the computer-executable components further comprise:
a training component that trains the machine learning model on the training dataset.

8. A computer-implemented method for producing warnings or recommendations regarding data store workloads based on machine learning classifications of such data store workloads, comprising:
accessing, by a device operatively coupled to a processor, a resource utilization descriptor that represents resource-consumption of a workload of a data store, wherein the resource utilization descriptor includes one or more computer processing unit utilization levels of the data store that are caused by the workload and one or more permanent computer memory utilization levels of the data store that are caused by the workload;
generating, by the device and via execution of a machine learning model on the resource utilization descriptor, a classification label that describes a characteristic of the workload of the data store, wherein the machine learning model receives as input the resource utilization descriptor, and wherein the machine learning model computes as output the classification label; and
generating, by the device, one or more warnings or recommendations based on the classification label.

9. The computer-implemented method of claim 8, wherein the resource utilization descriptor further includes one or more temporary computer memory utilization levels of the data store that are caused by the workload and one or more network bandwidth utilization levels of the data store that are caused by the workload.

10. The computer-implemented method of claim 8, wherein the classification label identifies a computing fault afflicting the workload of the data store, and wherein the generating one or more warnings or recommendations includes transmitting, by the device and to a client device, a warning that flags the computing fault or a recommendation for remedying the computing fault.

11. The computer-implemented method of claim 8, wherein the classification label identifies a resource of the data store that is being underutilized by the workload, and wherein the generating one or more warnings or recommendations includes transmitting, by the device and to a client device, a suggestion that utilization of such resource be increased.

12. The computer-implemented method of claim 8, wherein the classification label indicates a resource of the data store that is being overutilized by the workload, and wherein the generating one or more warnings or recommendations includes transmitting, by the device and to a client device, a suggestion that utilization of such resource be decreased.

13. The computer-implemented method of claim 8, wherein the classification label indicates that the workload could be successfully transplanted to a different data store, and wherein the generating one or more warnings or recommendations includes transmitting, by the device and to a client device, a recommendation that the workload should be transplanted to the different data store.

14. The computer-implemented method of claim 8, wherein the classification label indicates that the workload could not be successfully transplanted to a different data store, and wherein the generating one or more warnings or recommendations includes transmitting, by the device and to a client device, a recommendation that the workload should not be transplanted to the different data store.

15. The computer-implemented method of claim 8, further comprising:
accessing, by the device, a training dataset comprising a set of training resource utilization descriptors; and
training, by the device, the machine learning model on the training dataset.

16. A computer program product for facilitating machine learning classification of workloads of a data store so as to support provision of tailored warnings or recommendations regarding the data store, the computer program product comprising a computer-readable memory having program instructions embodied therewith, the program instructions executable by a processor to cause the processor to:
access a resource utilization descriptor conveying how a workload handled by a data store causes various resources of the data store to be consumed, wherein the resource utilization descriptor indicates a computer processing unit utilization level of the data store that is caused by the workload, a temporary computer memory utilization level of the data store that is caused by the workload, a permanent computer memory utilization level of the data store that is caused by the workload, and a network bandwidth utilization level of the data store that is caused by the workload;
execute a machine learning model on the resource utilization descriptor, thereby yielding a classification label that qualifies the workload, wherein the machine learning model takes as input the resource utilization descriptor and calculates as output the classification label; and
transmit, to a client device associated with the workload, at least one warning or recommendation based on the classification label.

17. The computer program product of claim 16, wherein the machine learning model is a deep learning neural network, wherein an input layer of the deep learning neural network receives as input the resource utilization descriptor, wherein the resource utilization descriptor passes through one or more hidden layers of the deep learning neural network, and wherein an output layer of the deep learning neural network produces as output the classification label.

18. The computer program product of claim 16, wherein the machine learning model is a random forest model comprising an ensemble of decision trees, wherein root nodes of the ensemble of decision trees receive as input the resource utilization descriptor, wherein leaf nodes of the ensemble of decision trees generate preliminary classifications for the resource utilization descriptor, and wherein the classification label is based on an average of the preliminary classifications.

19. The computer program product of claim 16, wherein the resource utilization descriptor indicates multiple computer processing unit utilization levels of the data store that are caused by the workload, multiple temporary computer memory utilization levels of the data store that are caused by the workload, multiple permanent computer memory utilization levels of the data store that are caused by the workload, and multiple network bandwidth utilization levels of the data store that are caused by the workload.

20. The computer program product of claim 16, wherein the classification label indicates:
a computing fault of the workload;
a resource of the data store that is being underutilized or overutilized by the workload; or
whether the workload can be successfully transplanted to a different data store.
